(19) United States
(12) Patent Application Publication
(10) Pub. No.: US 2024/0060197 A1
(43) Pub. Date: Feb. 22, 2024

(54) MAGNETOHYDRODYNAMIC DEVICE AND METHOD FOR GAS PRODUCTION IN MICROGRAVITY

(71) Applicant: Georgia Tech Research Corporation, Atlanta, GA (US)

(72) Inventor: Alvaro Romero Calvo, Atlanta, GA (US)

(21) Appl. No.: 18/453,222

(22) Filed: Aug. 21, 2023

Related U.S. Application Data
(60) Provisional application No. 63/399,784, filed on Aug. 22, 2022.

(51) Int. Cl. C25B 9/60; C25B 1/04; C25B 9/015; C25B 9/19; C25B 15/08

(52) U.S. Cl. CPC C25B 9/60; C25B 1/04; C25B 9/015; C25B 9/19; C25B 15/08

(57) ABSTRACT

An exemplary magnetohydrodynamic device, system, and method (e.g., electrolyzer or separator device) for gaseous production and separation in low or microgravity environments that employ magnetohydrodynamic (MHD) forces, e.g., Lorentz force and effects generated by magnetic force and applied current, to form a vortical flow within a separation chamber. The exemplary magnetohydrodynamic device, system, and method employ electrodes to electrolyze a liquid to produce gas bubbles and to generate the Lorentz force, from the applied current in combination with a magnetic field, that urges the bubbles by the vortical flow to an outlet of a separation chamber and thus separating the gas from the liquid medium. The exemplary device, system, and method can be used to electrolyze and separate for use in life support systems, and propulsion systems, among others described herein.

### RELATED APPLICATION

This application claims priority to, and the benefit of, U.S. Provisional Patent Application No. 63/399,784, filed Aug. 22, 2022, entitled “Magnetohydrodynamic Drive for Gas Production in Microgravity,” which is incorporated by reference herein in its entirety.

### BACKGROUND

Reliability and mass are often the driving factors in the design, particularly for critical systems, of systems for space applications. The absence or reduction of gravity-induced buoyancy forces in microgravity or low gravity environment poses technical challenges to the management of multiphase flows in the equipment of spacecraft, space vehicles, landers, space stations, and the like.

Multiphase flows occur when there is a liquid phase and a gas phase of the liquid in a liquid medium. Electrolyzers and separators are examples of systems that have multiphase flow in a liquid stream, e.g., when producing oxygen, electrolyte, and/or chemical, e.g., for usage by other systems in a spacecraft, space vehicle, lander, space station, etc. One such system includes the Environmental Control and Life Support System (ECLSS), e.g., at the International Space Station (ISS), which employs an Oxygen Generator Assembly (OGA) to move wastewater through a membrane of an oxygen separation module via forced convective flows. These active systems can have high energy use, high mass, and high complexity.

There is a benefit to improving the production or separation of multiphase liquid in micro or low-gravity systems.

### SUMMARY

An exemplary magnetohydrodynamic device, system, and method (e.g., electrolyzer or separator device) are disclosed for gaseous production and separation in low or microgravity environments that employ magnetohydrodynamic (MHD) forces, e.g., Lorentz force and effects generated by magnetic force and applied current, to form a vortical flow within a separation chamber. The exemplary magnetohydrodynamic device, system, and method employ electrodes to electrolyze a liquid to produce gas bubbles and to generate the Lorentz force from the applied current in combination with a magnetic field that urges the bubbles by the vortical flow to an outlet of a separation chamber and thus separating the gas from the liquid medium. The exemplary magnetohydrodynamic device, system, and method can operate solely by the energization of the electrodes and via magnetic fields (e.g., from permanent magnets or localized field generators), when using Lorentz force, without the use of moving parts or components in the electrolysis and separation operation and thus provides a more reliable and energy-efficient gas production devices and systems. In some embodiments, the exemplary device or system can operate with external mechanical devices to provide additional kinetic forces to assist in the separation. The exemplary magnetohydrodynamic device, system, and method can be optimized for mass and have substantially lower mass than state-of-the-art Oxygen Generator Assembly devices. The exemplary device, system, and method can be used to electrolyze and separate for use in life support systems and propulsion systems, among others described herein.

In an aspect, a magnetohydrodynamic device (e.g., for propulsion, life support, electrolysis, etc.) configured for gas production and phase separation is disclosed that includes: a housing having a first side (e.g., top side), a second side (e.g., bottom side), and a sidewall defining an inner volume; one or more permanent magnets or electromagnetic source modules arranged adjacent to the sidewall and configured to generate static magnetic or electromagnetic fields directed radially inwards towards the inner volume; at least two electrodes, including a first electrode and a second electrode, disposed within the inner volume and spaced apart from each other in an axial direction; an inlet defined by an opening in the housing and configured to deliver a liquid to the inner volume; and an outlet defined in the housing at the first side and configured to expel a gas, generated from the liquid, from the inner volume; wherein a current is applied between the first and second electrodes (a), and in the static magnetic or electromagnetic field, to generate a Lorentz force in a direction perpendicular to both (i) the applied current and (ii) the static magnetic or electromagnetic fields, the Lorentz force exerting a circumferential acceleration on the liquid to form a vortical flow within the inner volume and (b) the first and second electrodes electrolyze the liquid to form the gas while the vortical flow urges the gas toward the outlet through the generation of centripetal acceleration.

In some implementations, the liquid includes an electrolyte, and the first and second electrodes, collectively, form an electrolytic cell.

In some implementations, the vortical flow, while the device is in a microgravity or low gravity environment, separates the liquid from the gas by urging the gas toward the outlet and urging the liquid toward the sidewall.

In some implementations, the housing is cylindrical (e.g., having a diameter of 40 cm or less).

In some implementations, the device further includes a central membrane extending at least partially between the first electrode and the second electrode, wherein the first and second electrodes form an electrolytic cell, wherein the first electrode is closer to the first side of the housing and the second electrode is closer to the second side of the housing.

In some implementations, the device further includes a second outlet defined in the housing at the second side and configured to expel a second gas, generated from the liquid, from the inner volume of the housing, wherein the gas as a first gas (e.g., H2) is generated from the liquid at the first electrode, and wherein the first and second electrodes electrolyze the liquid to form the second gas at the second electrode (e.g., O2) while the vortical flow urges the second gas toward the second outlet.

In some implementations, the central membrane separates the first gas from the second gas. In some implementations, a device, wherein the liquid is water, the first gas is hydrogen gas, and the second gas is oxygen gas. In some implementations, a device, wherein the outlet is configured to expel the gas in combination with a liquid form of the gas, and wherein the vortical flow within the inner volume urges the gas and the liquid form of the gas to exit through the outlet.

In some implementations, the first electrode and the second electrode are configured as a photoelectrochemical cell that is configured to electrolyze the liquid using light (e.g., solar light) that is shown on a portion of the first electrode and the second electrode.

In some implementations, the gas is directed to a combustion chamber, or a storage tank thereof, for use in propulsion, life support, in-situ resource utilization, or carbon dioxide reduction.

In some implementations, the two electrodes further include a third electrode and a fourth electrode, wherein the current is applied between the third and fourth electrodes to electrolyze the liquid to form the gas while the vortical flow urges the gas toward the outlet. In some implementations, a device, wherein the third and fourth electrodes is in the static magnetic or electromagnetic field and generate the Lorentz force in the direction to form the vortical flow when the current is applied thereto.

In some implementations, the gas is directed to a life support system or a storage tank thereof. In some implementations, a device further includes: a storage tank configured to house the expelled gas (e.g., for a propulsion or life support system).

In some implementations, the device further includes a motor configured to rotate the housing, the rotation assisting in the formation of the vortical flow. In some implementations, a device further includes: a pump, wherein the pump is configured to move the liquid into the housing at a pre-defined volume or velocity (e.g., wherein the liquid is introduced into the housing in a direction tangential to the sidewall).

In another aspect, a method of performing electrolysis is disclosed, the method including: providing a magnetohydrodynamic drive having (i) at least two electrodes and (ii) one or more permanent magnets or electromagnetic source modules; causing a liquid electrolyte to flow into the magnetohydrodynamic drive via an inlet; and generating and separating at least one gas from the liquid electrolyte by: applying a current between the at least two electrodes in proximity to a radially directed static magnetic or electromagnetic field produced by the one or more permanent magnets or electromagnetic source modules, (i) to generate a Lorentz force in a direction perpendicular to both of the applied current and the static magnetic or electromagnetic fields, the Lorentz force exerting a centripetal acceleration on the liquid electrolyte to form a vortical flow within the magnetohydrodynamic drive, and (ii) to electrolyze the liquid electrolyte to form the at least one gas while the vortical flow urges the gas toward an outlet.

In some implementations, the method includes expelling, via the outlet of the magnetohydrodynamic drive, the gas from the magnetohydrodynamic drive (e.g., to a storage tank, a propulsion drive for propulsion, a life support system as breathable gas, or for an ammonia production for fertilizer production). In some implementations, the liquid electrolyte includes water or a solution (e.g., photoelectrochemical solution, or alkaline solutions (e.g., of NaOH or KOH)).

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIGS. 1A-1G each shows an example magnetohydrodynamic device configured for gas production and phase separation using a magnetohydrodynamic force in accordance with an illustrative embodiment.

FIGS. 2A and 2B each show a diagram of an example oxygen generation system implementing the magnetohydrodynamic (MHD) device (e.g., the device of FIGS. 1A-1G), according to an illustrative embodiment.

FIGS. 3A and 3B show a simulated magnetic field for Lorenz force for a cell in an example magnetohydrodynamic device.

FIG. 4 shows an example propulsion system employing an example magnetohydrodynamic device, according to an illustrative embodiment.

FIGS. 5A-5C show simulated operations and characterizations of the anode and cathode for an example magnetohydrodynamic drive. Specifically, FIG. 5A shows a graph of the contribution of anode and cathode overpotentials for an alkaline electrolysis cell. FIG. 5B shows the simulation output of the variation of the electrical current with the potential difference for the MHD drive. FIG. 5C is the simulation output showing current-overpotential curves for the MHD drive.

FIGS. 6A-6H show experimental results relating to the generation of vortical flow using an example magnetohydrodynamic device using a ZARM's Drop Tower. Specifically, FIG. 6A shows an image of an MHD drive demonstrator tested at ZARM's Drop Tower. FIG. 6B shows a series of images with corresponding time stamps for the MHD drive in ZARM's Drop Tower starting from no initial velocity and showing the path of a visible bubble. FIG. 6C shows a graph of the average angular position for bubbles, according to one implementation. FIG. 6D shows a model prediction graph for angular velocity variation with intensity, according to one implementation. FIG. 6E shows the magnetic field model generated by a radially-magnetized ring magnet assembly, according to one implementation. FIG. 6F shows a graph of the radial position of two larger-than-average bubbles over time, according to one implementation. FIG. 6G shows a graph of the experimentally observed terminal radial velocity of bubbles and terminal radial velocity predicted by the model, according to one implementation. FIG. 6H shows a graph with a Reynolds number along the radius for an electrical current intensity of 1 A, with different bubble diameters for Drag-Buoyancy balance, according to one implementation.

FIGS. 7A-7I show experimental results relating to gas production using an example magnetohydrodynamic device. The examples and values in FIGS. 7A-7I are merely illustrative. Specifically, FIG. 7A shows a graph of gas production variation with MHD drive height for a constant dₑ for ΔV=3V, according to one implementation. FIG. 7B shows a graph of gas production variation with MHD drive distance between electrodes for a constant H=5 cm, according to one implementation. FIG. 7C shows a graph of gas production variation with Ri/Re ratio for constant dₑ=0.5 cm, H=5 cm, and ΔV=3 V, according to one implementation. FIG. 7D shows a graph of MHD drive mass variation with size, according to one implementation. FIG. 7E shows a graph of, power variation with MHD drive size according to one implementation. FIG. 7F shows a graph of ωₛᵣ variation with electrode distance and external radius, according to one implementation. FIG. 7G shows a graph of R_{eq} variation with electrode distance and external radius, according to one implementation. FIG. 7H shows a graph of ωₛᵣ variation with a potential difference and external radius, according to one implementation. FIG. 7I shows a graph of R_{eq} variation with a potential difference and external radius, according to one implementation.

FIGS. 8A-8B show experimental results relating to the magnetic force to be employed in forming the Lorentz force. Specifically, FIG. 8A shows a graph of ωₛᵣ variation with magnet thickness and external radius, according to one implementation. FIG. 8B shows a graph of R_{eq} variation with magnet thickness and external radius, according to one implementation.

FIGS. 9A-9B show simulation results for an example MHD drive design. Specifically, FIG. 9A shows the simulation of MHD drive design with a magnetic field induced by the 5.175 mm magnet, according to one implementation. FIG. 9B shows a diagram of volumetric Lorentz force produced by the combination of the magnetic field and the electrical current intensity, according to one implementation.

FIGS. 10A-10B show an example system operation of a propulsion system using an example magnetohydrodynamic device. Specifically, FIG. 10A shows a graph of Iₛₚ variation with operating pressure for a stochiometric mixture of H₂ and O₂ at 300K, according to one implementation. FIG. 10B shows a graph of variation of C_{F}, Iₛₚ, and Dₜ for a gaseous mixture of H₂ and O₂ at 300K and 10 bar, according to one implementation.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entireties and to the same extent as if each reference was individually incorporated by reference.

Example Magnetohydrodynamic Devices

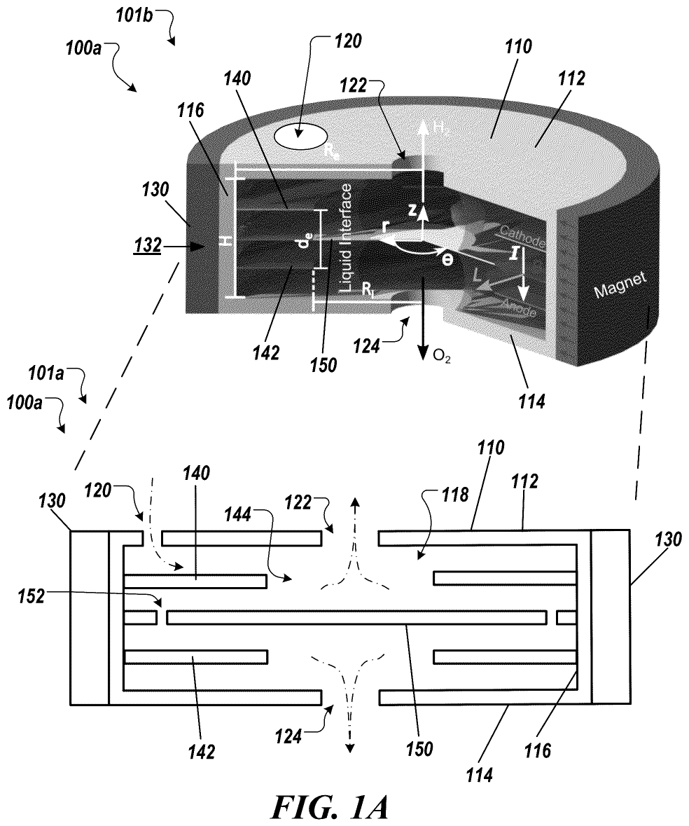

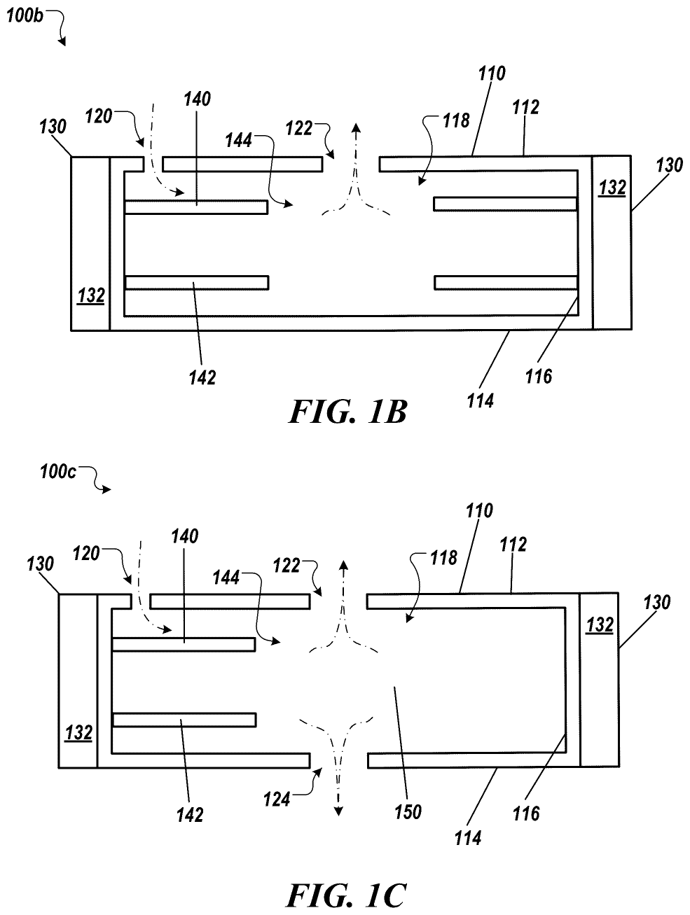

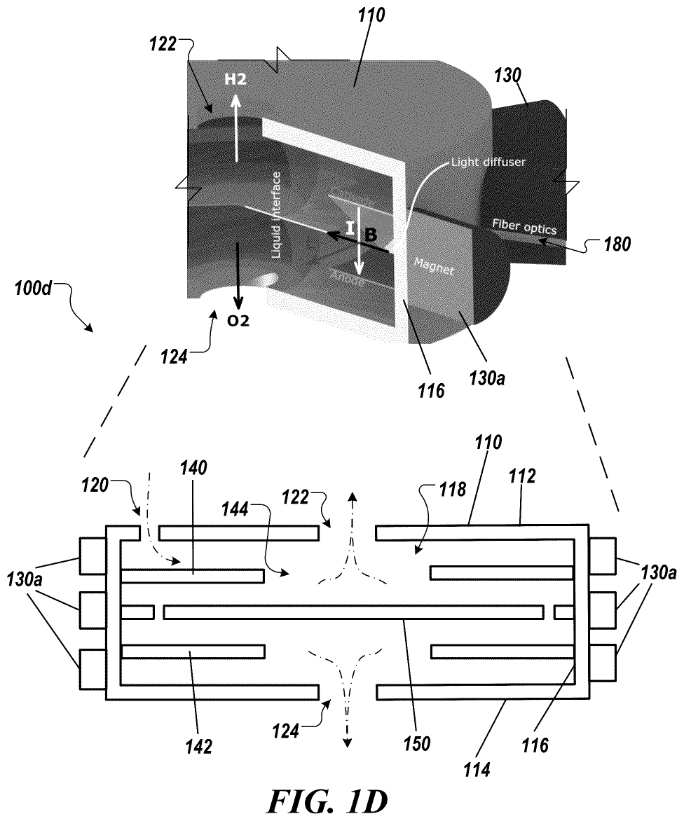

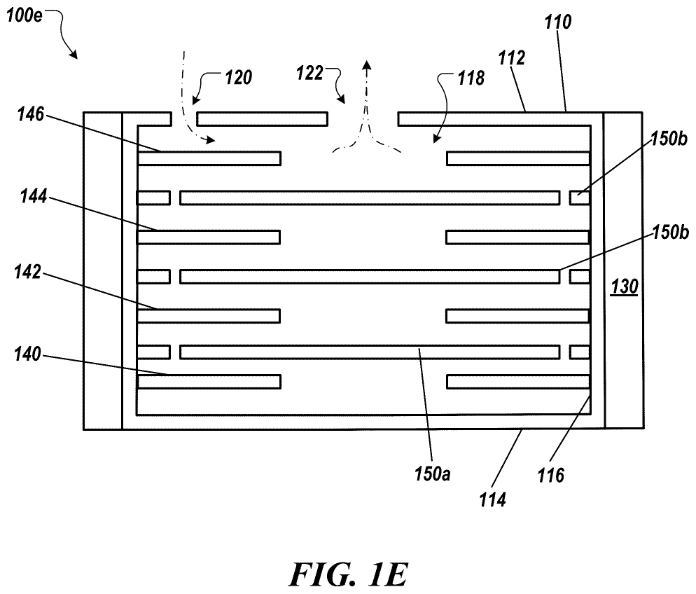

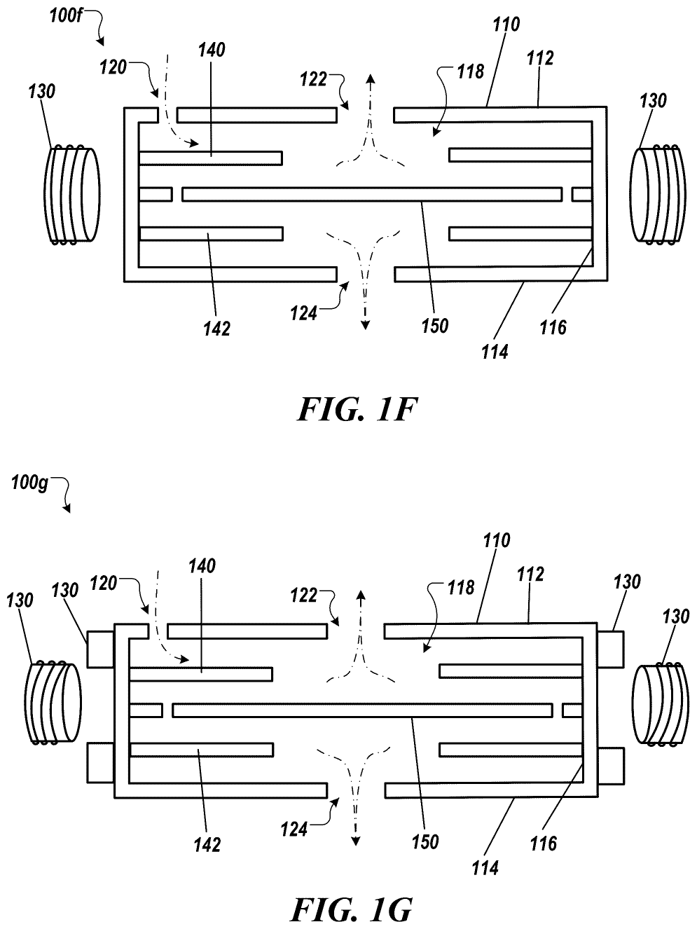

FIGS. 1A-1G each shows an example magnetohydrodynamic device 100 configured for gas production and phase separation using a magnetohydrodynamic force, e.g., for propulsion, life support, electrolysis, etc., in accordance with an illustrative embodiment.

In FIG. 1A, the magnetohydrodynamic device 100 (shown as 100a) includes a housing 110, an inlet 120, a first outlet 122, a second outlet 124, a magnetic field source 130, a first electrode 140, a second electrode 142, and a central membrane 150. The device 100a is configured to operate in a low or microgravity environment and employs magnetohydrodynamic (MHD) forces, e.g., Lorentz force generated by magnetic force and applied current, to form a vortical flow within a separation chamber to assist with an electrolyzer operation. Electrodes 140, 142 are configured to electrolyze a liquid, provided from the inlet 120, to produce gas bubbles and to generate the Lorentz force from the applied current in combination with the magnetic field, which urge the bubbles by the vortical flow to the outlet 122, 124 of the separation chamber and thus separating the gas from the liquid medium. FIG. 1A shows both a cross-sectional view 101a of the device 100a and a perspective view 101b of the same.

The housing 110 includes a first side 112 (e.g., a top side) and a second side 114 (e.g., a bottom side). The housing 110 further includes a sidewall 116 defining an inner volume 118 of the separation chamber to perform the gas production and phase separation. The housing 110 in this example is cylindrical; however, in other implementations, the internal surface of the housing may have a variety of different geometries (e.g., oval, spherical, grooved to direct flow).

The inlet 120 is defined as an opening on the first side 112 of the housing and is configured to deliver and/or allow fluid to flow into the inner volume 118. The inlet 120 may be placed in a variety of locations around the housing 110. For example, in some implementations, the inlet is disposed on the second side or on the sidewall (e.g., extending through the magnetic field source 130). In some implementations, multiple inlets are disposed around the housing.

The first outlet 122 is defined in the housing 110 at the first side 112, being substantially centrally located with respect to the inner volume 118. The second outlet 124 is defined in the housing 110 at the second side 114 being substantially centrally located with respect to the inner volume 118. Each of the first outlet 122 and the second outlet 124 are configured to expel a fluid (e.g., a gas) from the inner volume 118. In FIG. 1B, the magnetohydrodynamic device 100 (shown as 100b) includes a single outlet 122. In FIG. 1C, the magnetohydrodynamic device 100 (shown as 100c) includes two or more than two outlets (122, 124). In other implementations, the outlet(s) are disposed on the different areas of the housing (e.g., the sidewall or both on the first side). The outlet 122 or 124 may be formed of multiple ports.

The magnetic field source 130 is arranged adjacent to the sidewall 116. In the example shown in FIG. 1A, the magnetic field source 130 is formed as a single, circular magnet that extends circumferentially around the sidewall 116 to generate a static magnetic field 132 that directs radially inwards towards the inner volume 118, including to the electrodes (e.g., 140, 142) (see magnetic field vector 132).

The first electrode 140 and a second electrode 142 are disposed within the inner volume 118 spaced apart from each other in an axial direction with respect to the housing 110. In the example shown in FIG. 1A, the first electrode 140 is configured as a cathode, and the second electrode 142 is configured as an anode for an electrolytic cell. In this example, each of the first electrode 140 and second electrode 142 is ring-shaped and extends from the inner volume side of the sidewall 116 and partially into the inner volume 118, to define a central space 144 aligned with each of the first outlet 122 and the second outlet 124. FIG. 1C shows a configuration in which the electrodes extend only partially around the sidewall.

The volume 118 of the separation chamber are separated into two volumes by the central membrane 150. Recombination of the separated phases/fluids is prevented with an intermediate porous membrane (e.g., central membrane 150). The central membrane 150 extends at least partially between the first electrode 140 and the second electrode 142 from the inner volume side of the sidewall 116 and into the inner volume 118. In FIG. 1A, the central membrane includes openings or perforations 152 extending from one side to the other to allow fluid to move from a top side to a bottom side of the inner volume in areas adjacent to the sidewall of the housing. In some implementations, the central membrane does not include openings therein (e.g., where two inlets may be used to provide fluid to the inner volume).

Example Method of Operation

FIG. 1A also shows an example method of operation. Referring to diagram 101b, the sidewall 116 has a height marked as “H,” the housing 110 has a radius marked as “Rₑ”, and the central space 144 is defined by the extension of the first electrode 140 and the second electrode 142 has a radius marked as “Rᵢ.” The distance between the first electrode 140 and the second electrode 142 is marked as “dₑ”. In device 100a, the liquid is water, and the gases expelled from the housing 110 are oxygen (O₂) and hydrogen (H₂).

In use, the device 100a introduces a fluid (e.g., water, a liquid comprising an electrolyte) into the inner volume 118 of the housing 110 through the inlet 120. The device 100a applies a current between the first electrode 140 and the second electrode 142. Diagram 101b shows an example applied current between the electrodes (shown as vector “I,” extending from the cathode 140 to the electrode 142).

The magnet field source 130 creates a static magnetic field 132 (shown as vector “B”). With the current I is applied adjacent and perpendicular to the magnetic field “B” (e.g., static magnetic field, shown as 132), a resulting Lorentz force is generated (shown as vector “L”). The Lorentz force is generated in a direction perpendicular to both (i) the applied current and (ii) the static magnetic field, e.g., a cross product of the current “I” and the magnetic field “B” as in Equation 1.

L=I×B (Eq. 1)

The Lorentz force exerts a centripetal acceleration force on the fluid (e.g., liquid water) in the inner volume 118 to form a vortical flow of the fluid within the inner volume 118, in part, within the microgravity or low gravity environment. In the microgravity environment, the vortical flow urges the denser portions of the fluid (e.g., the liquid) to the edges of the inner volume 118 (e.g., adjacent to the sidewall 116). The less dense portions of the fluid (e.g., the gas) are urged toward the middle of the inner volume 118 away from the sidewall 116. Thus, the gas escapes through the first outlet 122 and/or the second outlet 124. The intermediate porous membrane (e.g., central membrane 150) prevents recombination of the generated hydrogen and oxygen, urging each to a separate outlet. Ultimately, hydrogen and oxygen bubbles are generated, separated, and collected by the device 100a without moving parts.

The first electrode 140 (cathode) and the second electrode 142 (anode), in FIG. 1A, form an electrolyzer with a current applied therebetween. The applied current between the cathode 140 and anode 142 electrolyzes the fluid (e.g., liquid) to form a gas. For example, the fluid may be water and the gas generated may be hydrogen (H₂) (e.g., from the first electrode 140) and oxygen (O₂) (e.g., from the second electrode 142). The exemplary magnetohydrodynamic device may be used for carbon dioxide reduction and fuel or fertilizer production. Electrolytes used in the exemplary magnetohydrodynamic device include KOH, NaOH, MnSO4, or, in general, any electrolyte used in any electrochemical reaction that involves multiphase flows.

The expelled gas can be directed for use in a separate/external system, e.g., of a spacecraft, vehicle, or station. For example, in some implementations, the gas is directed to a combustion chamber, or a storage tank thereof, for use in propulsion. In other implementations, the gas is directed to a life support system or a storage tank thereof. In other implementations, the gas is directed to an in-situ resource utilization system. In other implementations, the gas is directed to a carbon dioxide reduction system.

In some implementations, one or more of the outlets is configured to expel the gas in combination with a liquid form of the gas wherein the vortical flow within the inner volume urges the gas and the liquid form of the gas to exit through the outlet.

In some implementations, the device further includes a pump configured to move the liquid into the housing at a pre-defined volume or velocity (e.g., wherein the liquid is introduced into the housing in a direction tangential to the sidewall). In other implementations, the device includes a motor configured to rotate the housing, the rotation assisting in the formation of the vortical flow. Such a system may be used in low-gravity environments (e.g., the Moon) to supplement the Lorentz force's centripetal acceleration.

Additional Example Magnetohydrodynamic Devices

Referring to FIGS. 1B-1G each shows an example magnetohydrodynamic device 100 (shown as 100b-100g) configured for gas production and phase separation using a magnetohydrodynamic force, e.g., for propulsion, life support, electrolysis, etc., in accordance with an illustrative embodiment.

Examples #2 and #3. FIGS. 1B and 1C show additional configurations of the magnetohydrodynamic device 100 (shown as 100b and 100c) of FIG. 1A that does not include a central membrane 150. In FIG. 1B, the device 100b is similar to that described in FIG. 1A but does not include the central membrane 150 and includes a single outlet 122, resulting vortical flow forces gas produced by the electrolyzer out through the single first outlet 122. The outlet 122 may be placed on the opposite wall (e.g., as outlet 124).

In FIG. 1C, the device 100c is similar to that described in FIG. 1A but does not include the central membrane 150 and includes two opposite outlets 122, 124. In addition, device 100c includes electrodes 140 and 142 that extend only partially around the sidewall 116. For example, the electrodes 140 and 142 may extend only 1/16, ⅛, 3/16, ¼, 5/16, ⅜, 7/16, ½, 9/16, ⅝, 11/16, ¾, 13/16, ⅞, 15/16 of the way around the periphery of the sidewall 116. The device 100c may accommodate other elements and geometries within the inner volume 118, allowing for a more complex device overall.

Example #4. FIG. 1D shows another configuration of the magnetohydrodynamic device 100 (shown as 100d) of FIG. 1A with multiple distinct magnetic sources 130 (shown as 130a). The bottom diagram of FIG. 1D shows the magnet field source 130a implemented as a plurality of permanent magnets arranged in among multiple rows in a circumferential pattern around the sidewall. The top diagram shows the magnet field source 130a implemented in a single row.

Each discrete magnet 130 produces a magnetic field adjacent to the first electrode 140 and second electrode 142 in the inner volume 118, similar to device 100a.

Indeed, many smaller magnets can be produced, leading to manufacturability efficiencies. Additionally, the device 100d is not limited in size by the manufactured size of the magnet 130.

FIG. 1D also shows the device 100 configured with a fiber-optic input 180 extending through the sidewall 116 that can power the electrodes. In FIG. 1D, the first electrode 140 and second electrode 142 of device 100d are configured as a photoelectrochemical cell configured to electrolyze the liquid using light (e.g., solar light). The light is shown on a portion of the first electrode 140 and the second electrode 142. Such a system/device could operate without an external electric power supply.

Example #5. FIG. 1E shows another configuration of the magnetohydrodynamic device 100 (shown as 100e) of FIG. 1A with a plurality of electrodes arranged in a stack configuration. The device 100e includes a first electrode 140, a second electrode 142, a third electrode 144, and a fourth electrode 146. However, in other implementations, the device may include a greater number of electrodes, e.g., 4, 5, 6, 7, 8, etc. In some embodiments, the number of electrodes is greater than 9, e.g., up to 20.

Similar to device described in relation to FIG. 1A, a current is applied between the electrodes of device 100e to electrolyze the liquid to form a gas (e.g., from water into hydrogen and oxygen gas). In some implementations, the electrodes are formed as anode-cathode pairs. For example, the first electrode 140 and second electrode 142 form one electrolysis unit, and the central space 144 and the fourth electrode 146 for another electrolysis unit.

Example #6. FIG. 1F shows another configuration of the magnetohydrodynamic device 100 (shown as 1000 of FIG. 1A with an electromagnetic field generator 130b as the magnetic field source 130. The electromagnetic field generator 130b is electrically powered to induce a magnetic field adjacent to the electrodes 140, 142.

Example #7. FIG. 1G shows another configuration of the magnetohydrodynamic device 100 (shown as 100g) of FIG. 1A with both permanent magnets 130a and electromagnetic field generators 130b as the magnetic field source 130. Each type of magnetic source module is configured to generate the magnetic fields for the magnetohydrodynamic (MHD) forces.

### Experimental Results and Additional Examples

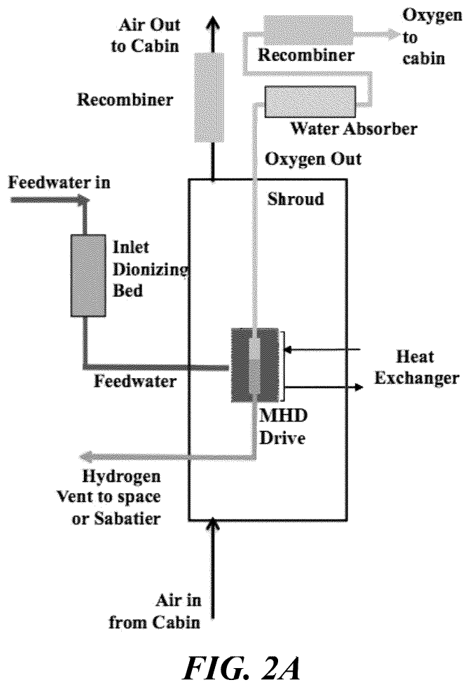

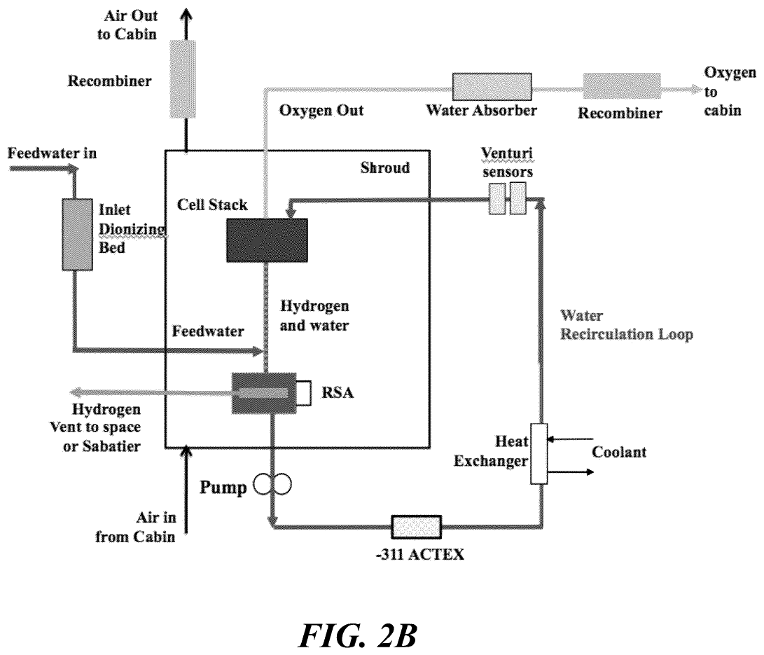

A study was conducted to develop magnetohydrodynamic devices for gas production system. FIGS. 2A and 2B each shows a diagram of an example oxygen generation system implementing the magnetohydrodynamic (MHD) device (e.g., the device of FIGS. 1A-1G), according to an illustrative embodiment.

Life Support System

FIG. 2A shows an example oxygen generation system 200 (shown as 200a) implementing the magnetohydrodynamic (MHD) device 100 for a life support system, e.g., to generate a breathable atmosphere during a Mars transfer mission, on-board the International Space Station, etc.

Sizing Analysis. The performance of the MHD drive may be configured based on the steady-state angular velocity of the electrolyte, ωₛᵣ, from which the centripetal phase separation effect follows. Based on the qualitative behavior observed in microgravity experiments, the core liquid volume may be modeled as a rigid body to which the angular velocity can be then computed from the balance of viscous and magnetohydrodynamic torques per Equation 2.

Tₛₕₑₐᵣ=T_{Lorentz}=∫∫_{S}τ·r dr dθ (Eq. 2)

In Equation 2, T_{Lorentz} is defined on the surfaces in contact with the liquid per Equation 3.

$$τ = μ \frac{du}{dz} \qquad ( Eq . 3 )$$

In Equation 3, τ is the shear stress, du/dz is the rate of change of the circumferential fluid velocity u in the normal direction to the shearing surface, and μ the dynamic viscosity. The magnetohydrodynamic torque can be expressed per Equation 4.

T_{Lorentz}=∫_{z1}^{z2}∫₀^{2π}∫_{R}_{ᵢ}^{R}^{ₑ}r²J_{z}Bᵣ(r,z)dzdθdr, (Eq. 4)

In Equation 4, Bᵣ is the radial magnetic field, J_{z} is the current density at the electrodes, and Rᵢ and Rₑ are the internal and external electrode radii, respectively. ωₛᵣ can be determined with some simplifying assumptions on the depth of the boundary layers.

Liquid rotation would pump the gas generated over the electrodes toward the center of the MHD drive. There is a minimum liquid interface radius Rₘᵢₙ at which the pumping capacity of the drive matches the ideal gas flow generation, which derives from the electrolysis reaction per Equation 5.

H₂O(l)→H₂(g)+½O₂(g). (Eq. 5)

An interference radius larger than Rₘᵢₙ may result in larger ωₛᵣ, and may enhance bubble removal efficiency. The power consumed to spin the liquid inside the MHD drive can be determined as T_{Lorentz}ωₛᵣ, which may be considered negligible in comparison with the power employed for the electrolysis reaction.

The system of FIG. 2A can be implemented for the International Space Station (ISS) Oxygen Generator Assembly (OGA). Table 1 shows example configurations for the MHD-based OGA (shown as “MHD drive”) and the current OGA (shown as “ISS OGA”) for three configurations (“standalone,” “ISS,” and “Mars Transfer.” The system of FIG. 2A would eliminate a water recirculation loop and related moving parts to provide a more straightforward and optimized system. FIG. 2B shows the current Oxygen Generator Assembly available on the International Space Station, the features of which may be incorporated into those described in relation to FIG. 2A.

TABLE 1

| | ISS OGA (kg) | | | MHD Drive (kg) | | |
|---|---|---|---|---|---|---|
| Component | Standalone | ISS | Mars Transfer | Standalone | ISS | Mars Transfer |
| Pump Controller | 37 | 111.6 | 148.8 | 20 | 60 | 100 |
| Pump | 10.5 | 31.3 | 41.7 | 0 | 0 | 0 |
| Inlet Deionizing Bed | 20 | 39.9 | 79.8 | 0 | 0 | 0 |
| Hydrogen Sensor | 4.5 | 13.6 | 18.1 | 4.5 | 13.6 | 18.1 |
| Oxygen Outlet | 33 | 65.3 | 130.6 | 32.7 | 65.8 | 130.6 |
| Feed water flow | 34.5 | 68.9 | 137.9 | 34.5 | 68.9 | 137.9 |
| control | | | | | | |
| Conventional | 125 | 250.4 | 500.8 | 25 | 50 | 100 |
| electrolysis unit (cell | | | | | | |
| stack, centrifuge, | | | | | | |
| dome) | | | | | | |
| Nitrogen Purge | 23 | 46.3 | 92.5 | 0 | 0 | 0 |
| Power Supply | 47 | 140.2 | 186.9 | 40 | 120 | 160 |
| Rack | 329 | 564.4 | 485.9 | 98.9 | 279.3 | 240.4 |
| ACTEX | 12 | 12.2 | 49.0 | 0 | 0 | 0 |
| MHD drive | 0 | 0 | 0 | 15 | 16 | 18 |
| Total | 675 | 1344.1 | 1872.0 | 349.5 | 630.6 | 945.8 |

As shown in Table 1, the electrodes and their fixtures would weigh roughly 1 kg and could be the only components subject to degradation inside the MHD drive, together with the lightweight gas-rejection membrane between the electrodes to provide a life operation of at least 60,000 hours. The elimination of the rotary phase separator (centrifuge), cell stack, and water recirculation loop would lead to a decrease in the mass of the rack, process controller, and power supply. The table indicates that the exemplary MHD drive system could reduce the mass of the OGA by up to 50% while also employing less power (e.g., just a few Watts to generate the vortical flow for the phase separation).

A solar-powered magnetohydrodynamic drive (e.g., as shown in relation to FIG. 1) can be implemented with straightforward architecture to provide high reliability while having low mass and low power requirements. This can provide the safe and efficient recycling of oxygen in different spaceflight architectures.

In one application for the generation of breathable atmospheres during a Mars transfer mission, a crew of four needs 3.36 kg/day (2.34 g/min) of oxygen for a 225-day outbound+225-day inbound trip with a 485-day quiescent period in Mars orbit. 1512 kg are required during the whole mission, which must achieve a probability of loss of crew below 1%. This amount of oxygen can be produced in an alkaline electrolytic cell with two 1000 cm² platinum electrodes operating at 500 mA/cm² current density. Considering a fourth-junction gallium arsenide solar panel efficiency of 30%, a power transmission efficiency of 90%, and an electrolytic cell efficiency of 80%, 13 m² solar panels are required at the 586.2 W/m² worst-case Mars solar irradiance. The exemplary MHD drive may be configured with two cells operating at 65 bar and 300 K with 18 cm external and 13 cm internal radii electrodes to meet these requirements.

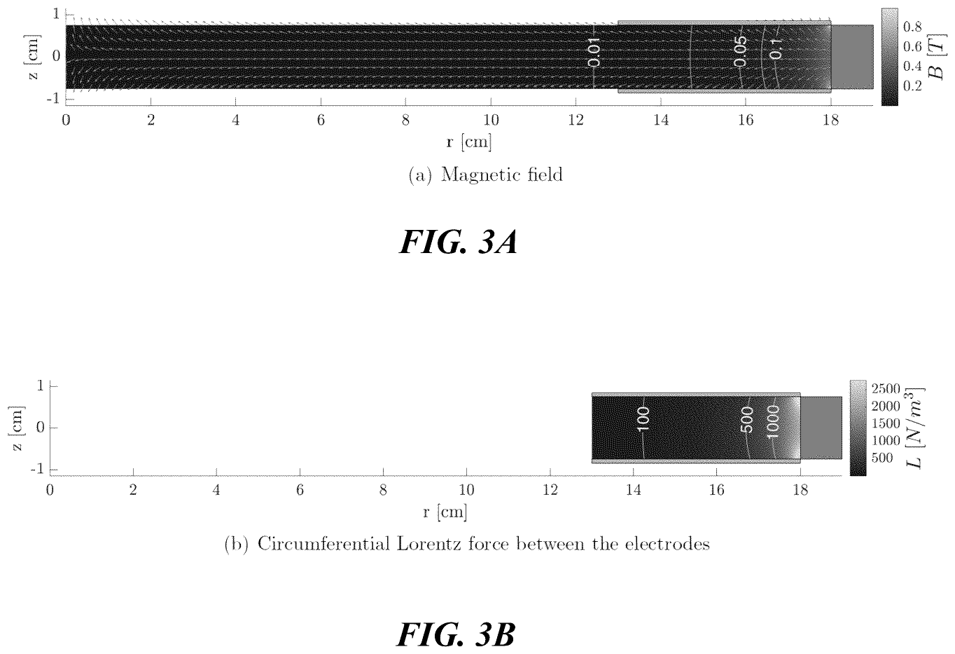

FIG. 3A shows simulated magnetic field produced from a cell. The cells employ 10 mm thick Al-7075 casings and a 10 mm thick neodymium ring that produces the required magnetic field [7]. Following a momentum balance approach, an electrolyte angular velocity of ωₛᵣ=≈470 deg/s is obtained for a minimum interface equilibrium radius of ˜6 mm under the influence of the circumferential Lorentz force [8]. FIG. 3B shows the simulated circumferential Lorentz force between electrodes. The resulting MHD drive mass is ˜10 kg plus ancillary components. The system consumes ˜1.2 kW to carry out the electrolysis reaction assuming a worst-case potential difference of 2.5 V, and less than 1 W to spin the liquid and compensate for viscous friction at the walls.

Example Propulsion System

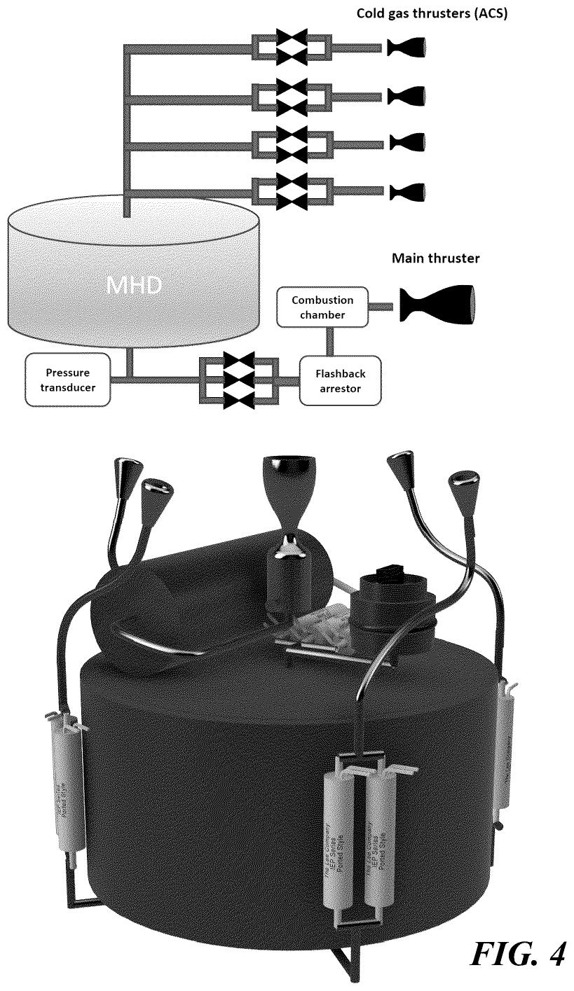

FIG. 4 shows the exemplary MHD device configured for propulsion, e.g., for CubeSats, and has technical benefits in leveraging the lack of gravitational forces in microgravity or low gravity environment in the phase separation operation that would otherwise employ active systems. CubeSats have many end-use applications. As missions become more intricate, the need for a propulsion system arises. Conventional rocket fuels have been considered impractical due to safety considerations.

The study developed and validated a model to analyze the influence of different parameters. The parametric analysis showed that gas production increases with a larger external radius, lower distance between electrodes, and higher potential difference. However, the external radius and the potential difference are limited to 5 cm and 2.8 V, respectively, to avoid exceeding 1 U and to avoid a drop in electrolysis efficiency. As for the angular velocity, increasing both potential difference and magnet thickness leads to a higher Lorentz force and, consequently to a higher angular velocity and a higher extraction capacity. However, the variation in the distance between electrodes does not affect the angular velocity, as it has two opposing effects that cancel each other out, i.e., a lower distance between electrodes increases the electrical current intensity while at the same time, reducing the volume where the Lorentz Force is applied. Regarding the extraction capacity, for every parametric study, there is a critical point where the gas produced cannot be evacuated from the space between electrodes due to high gas production, low angular velocity, a small distance between electrodes, or a combination of these factors. The extraction capacity improves with a higher potential difference and magnet size but worsens for a lower distance between electrodes.

The MHD design in the study, to maximize gas production and avoid MHD drive failure due to evacuation problems, included an external radius of 4.48 cm, a magnet with 5.175 mm of thickness, an applied voltage difference of 2.8 V, and a distance between electrodes of 0.5 cm. The developed model predicts an angular velocity of 185 degrees/s, a gas production rate of 14 g/hr, and an interface radius of 0.87 cm which is 19.7% of the external radius. This design has a mass of 1 kg and, according to the developed model, provides a change in velocity for a 14 kg CubeSat of, ΔU=4.32 m/s per hour.

The study developed a propulsion system for CubeSats and a corresponding MHD drive. The propulsion system included a main nozzle and combustion chamber for orbital maneuvers and small cold gas thrusters for the desaturation of the ADCS (reaction wheels). The operating pressure of the main thruster is set at 10 bar to achieve high specific impulse and thrust while having low structural requirements. For the main thruster, a balance is required between a small nozzle and good performance in terms of specific impulse. This balance was achieved for an expansion ratio of ∈=62, a throat diameter of Dₜ=1.27 mm, an exit diameter of Dₑ=9.378 mm, and a nozzle length of Lₙ=17.5 mm. These dimensions allow the burning of the gas produced during one hour of electrolysis in 28 seconds. The corresponding combustion chamber for this nozzle has a diameter of D_{cc}=6.34 mm and a length of L_{cc}=28.4 mm. The propulsion system's four small thrusters' optimal configuration for desaturation around three axes is discussed. To optimize the performance of the system, a study is conducted on the variation of the thrust coefficient and the specific impulse with the nozzle expansion ratio, revealing an asymptotic tendency. Based on this, the study used a nozzle expansion ratio of 200. For desaturation in 10 seconds, the study employed a thrust of 114.24 mN, a throat diameter of Dₜ=0.29 mm, exit diameter Dₑ=4.1 mm, and a nozzle length of Lₙ=7.1 mm, to provide the thrust and to desaturate the reaction wheels in the desired time frame. The 3D CAD model of FIG. 4 shows that the designed propulsion system can fit in 1U of a CubeSat, which makes it feasible for CubeSat propulsion.

It is contemplated that the system can be scaled to a larger size for larger applications and systems.

MHD Drive Modeling. The study developed a model that can provide i) the angular velocity of the fluid, which should depend on the electrical current intensity, the magnetic field, and the geometry, ii) the terminal velocity that the gas bubbles will have in the rotating fluid, which will dictate the flow rate of gas that can be extracted from the MHD drive, iii) the balance of produced gas in the electrolysis process and the amount of gas that can be extracted from the MHD drive, and finally, iv) the radius where the interface between water and gas will be located when this balance occurs.

i. Angular Velocity. The study developed an angular velocity model that was employed to estimate the angular velocity of water within an MHD device. Angular velocity directly influences the centripetal acceleration, which, in turn, can determine the radial terminal velocity of bubbles and the maximum gas flow rate getting out of the MHD drive.

Torque Balance. The angular velocity model includes a steady-state rotation speed that can be determined by a torque balance between the torque generated by the Lorentz force and the torque generated by the “friction” in the walls to obtain this steady-state rotation velocity. This “friction” can be modeled as a shear stress which slows down the fluid. With consideration given to the cylindrical configuration inherent in the MHD drive, the developed model establishes torque conservation in which the torque exerted by the shear stress and the torque generated by the Lorentz force must be equal and opposite per Tₛₕₑₐᵣ=— T_{Lorentz}.

Shear Stress Torque. The angular velocity model also includes the torque exerted by the surfaces of the device, which can be found by integrating the product of the shear stress and the radius τ(r)·r, over the circular surface of the MHD device per Equation 6.

Tₛₕₑₐᵣ=♭∫_{S}τ(r)·r dS (Eq. 6)

The shear stress can be expressed as τ=μdu/dz, where du/dz is the rate of change of the local fluid velocity u in the normal direction to the shearing surfaces z, and μ is the dynamic viscosity. By expressing Equation 6 in terms of the angular velocity, ω, the linear and angular velocity are related as u=ω·r, which allows the shear stress to be expressed in terms of the angular velocity per Equation 7.

$$τ = μ r \frac{d ω}{dz} \qquad ( Eq . 7 )$$

The model can employ a first-order approximation to estimate the shear stress per Equation 8. Because the no-slip condition dictates that the speed of the fluid at the boundary (relative to the boundary) is zero; although at some height from the boundary, the flow speed must equal that of the fluid. Thus, do) in Eq. 7 can be approximated as the difference between the angular velocity of liquid spinning as a rigid cylinder away from the wall (o) sr) and the angular velocity at the wall (0). Moreover, dz can be substituted in Eq. 7 by the boundary layer thickness expression δ, Equation. 9, which is the distance between a point with an angular velocity “0” and a point with an angular velocity equal to 0.99ωₛᵣ. This first-order simplification results in

$$τ ( r ) = μ r \frac{{ω}_{sr} - 0}{δ ( r )} \qquad ( 8 )$$

The angular velocity can be viewed as constant, while the linear velocity is not. The liquid farther from the center experiences a higher linear velocity, leading to higher shear stress. Conversely, the liquid closer to the center experiences a lower linear velocity, resulting in lower shear stress. The boundary layer thickness for fluid in the Blasius conditions can be very closely approximated per Equation 9.

$$δ = \frac{5}{\sqrt{R {e}_{x}}} x \qquad ( Eq . 9 )$$

Equation 9 is dependent on the Reynolds number, Re, and the characteristic length x, which can be defined as the volume of the system divided by its surface, x=V_{body}/A_{surface}. The variation of linear velocity can also affect the thickness of the boundary layer, which is dependent on the linear velocity. By substituting the linear velocity expression u=ωₛᵣ in the boundary layer thickness e as Reₓ=ωₛᵣrx/v, where v is the kinematic viscosity, the shear stress can be determined per Equation 10.

$${T}_{shear} = {[ \frac{4 {πμω}_{sr}^{\frac{3}{2}} {r}^{\frac{9}{2}}}{45 \sqrt{xv}} ]}_{{r}_{1}}^{{r}_{2}} \qquad ( Eq . 10 )$$

Lorentz Torque. The angular velocity model can include the torque exerted by the Lorentz force, which can be determined per Equation 11, with Bᵣ being the radial magnetic field (T), and J_{z} being the current density (A/m²). The magnetic Lorentz force density can be expressed as f_{L}=Jₑ×B. By considering only the terms in θ direction, f_{L,θ}=J_{z}Bᵣ−JᵣB_{z}, the JᵣB_{z} value can be neglected due to the architecture of the MHD drive, where there is no electrical current in the radial direction. The torque exerted by the Lorentz force can be expressed as the product of the applied force and the distance to the center of the drive.

T_{Lorentz}=∫_{V}rJ_{z}BᵣdV (Eq. 11)

ii. Gas Production. Gas production calculation for the MHD drive can determine the available propellant quantity and, consequently, the achievable thrust and change in velocity AU and expressed in terms of potential differences ΔV. That is, the mass flow rate through the propulsion system is constrained by gas production, primarily driven by the process of electrolysis.

Water Electrolysis. The gas volume production rate can be determined per Equation 12.

$${Q}_{produced} = ( \frac{( {\dot{n}}_{{O}_{2}} + {\dot{n}}_{{H}_{2}} ) RT}{P} ) \qquad ( Eq . 12 )$$

The water electrolysis process can be understood as the decomposition of water into oxygen and hydrogen. From the electrical current intensity I the mol of electrons per second \dot{n}_{O}=IC/N_{Δ′}, where N_{A} is Avogadro's number, and C is Coulomb's number. Thus, the mol of gas generated per unit of time, \dot{n}_{O}_{₂} and \dot{n}_{H}_{₂}, can be obtained as

$${\dot{n}}_{{O}_{2}} = \frac{\dot{} IC}{4 {N}_{A}} {n}_{{H}_{2}} = \frac{IC}{2 {N}_{A}} .$$

Overpotentials. The overall cell overpotential can be determined as a sum of the high activation energy barrier to split the atoms (cathode+anode), ohmic resistances (electric and ionic), and mass transport limitations inside the cell, per Equation 13.

θ_{Total}=θ_{Anode}+η_{Cathode}+η_{Ohmic}+η_{Mass} (Eq. 13)

In Equation θ_{Total} is the total cell overpotential, θ_{Anode} is the overpotential related to the activation losses at the anode, θ_{Cathode} is the overpotential related to the activation losses at the cathode, θ_{Ohmic} is the overpotential related to the sum of electric and ohmic resistances, and θ_{Mass} is the overpotential related to losses due to mass transport limitations.

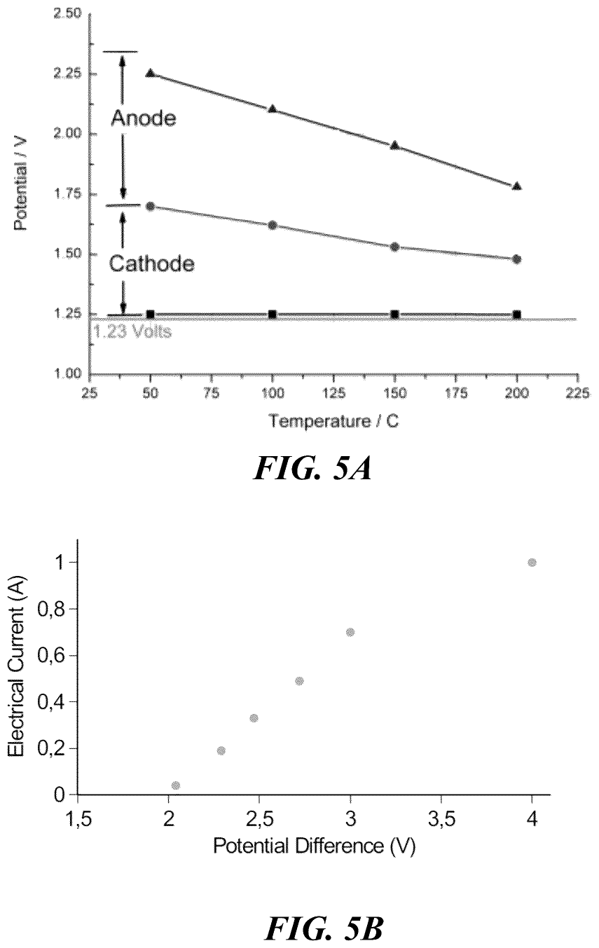

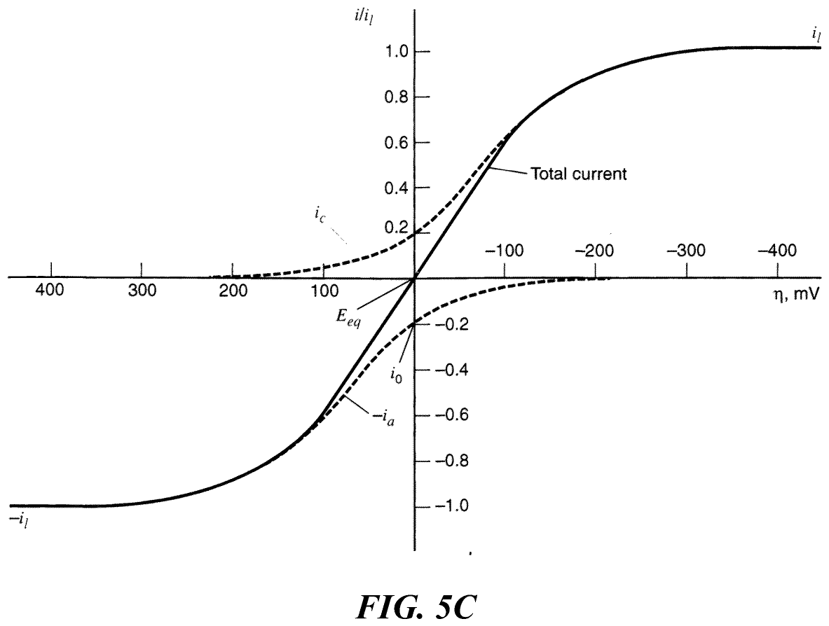

The thermodynamic potential of water electrolysis is 1.23 V at 25° C. and 1 atm (E₀). Under practical conditions, a higher potential difference, ΔV can be employed. In water electrolysis, overpotential η is the additional potential difference required to drive the desired electrochemical reaction at the electrodes compared to the thermodynamic potential, η=E_{cell}−E₀, where E₀ is the thermodynamic potential, and E_{cell} is the potential needed to drive the desired electrochemical reaction. FIG. 5A shows a graph of the contribution of anode and cathode overpotentials for an alkaline electrolysis cell.

Typical values of the overpotential for an alkaline electrolysis cell range from 2.25 to 1.75 depending on the temperature, which means that electrolysis will not happen if the potential difference is not higher than these values, as is shown in FIG. 5A. FIG. 5B shows that the total overpotential is θ_{Total}=2−1.23=0.77 V. Also, it can be observed that the variation of the electrical current with the potential difference is not linear for high potential differences (4 V).

Electrical Current Limit. When the potential difference applied across the electrodes exceeds a certain threshold, the increase in current becomes limited due to the mass-transfer effects. At low potential differences, the electrical current increases as the potential difference increases, following Ohm's Law. However, as the potential difference continues to rise, the overpotential also increases, which hinders the electrochemical reactions. Once the overpotential reaches a critical level, further increases in the potential difference have diminishing effects on the electrical current. FIG. 5B shows the simulation output of the variation of the electrical current with the potential difference for the MHD drive. FIG. 5C is the simulation output showing current-overpotential curves for the MHD drive.

Electrolyte Conductivity. In MHD, the expression for the current density (A/m²) is given by Ohm's law, Jₑ=κ_{c}(E+U×B) in which E denotes the electric field strength, U denotes the flow field, and Kc denotes the electric conductivity of the medium. The cross product of the magnetic field and the velocity of the flow is the inductive term. For the MHD drive, the flow velocity is relatively slow, |U|<0.15 m/s, and the magnetic field is also relatively small, |B|<0.2 T. Thus, the inductive term is at least 4 orders of magnitude smaller than the electric field and can be safely neglected. The electric field strength has units of V/m and can be expressed as ΔV/de. By disregarding the inductive term, the current intensity can be determined per Equation 14.

$$I = \frac{{κ}_{c} Δ VA}{{d}_{e}} \qquad ( Eq . 14 )$$

In Equation 14, A is the electrode surface and de being the distance between electrodes.

iii. Extraction Capacity. The extraction capacity plays a role in the operation of the MHD drive and can be determined by the terminal velocity of the bubbles in the radial direction, which can be determined using a drag-buoyancy balance. If the gas extraction rate of the device is insufficient compared to the gas production rate, the accumulated gas can gradually fill the space between the electrodes, displacing the water-electrolyte mixture and interrupting the electrolysis process. In short, if gas production is higher than the gas extraction capability, eventually, gas production may cease.

Drag-Buoyancy Balance. The terminal speed of a bubble in a fluid can be determined by analyzing the balance between the drag and buoyancy forces per Equation 15. This is valid for a fluid in a steady state and a bubble moving at its terminal velocity.

$${u}_{t} = \sqrt{\frac{4 g ( {ρ}_{L} - {ρ}_{G} ) {d}_{b}}{3 {C}_{D} {ρ}_{L}}} \qquad ( Eq . 15 )$$

In Equation 15, μ_{L}, ρ_{G} are the density of the liquid and the gas, respectively, g is the gravitational acceleration, d_{b} is the diameter of the bubble, C_{D} is the drag coefficient for the bubble, and uₜ is the terminal velocity.

The gravitational acceleration applied to the MHD device corresponds to the normal acceleration, which is the acceleration in the radial direction due to the fluid rotation. This can be represented as g=aₙ=ωₛᵣ²r. Eq. 15 for the terminal velocity, uₜ, depends on the drag coefficient C_{D} and diameter of the bubble d_{b}, which are unknown. For the drag coefficient, there is a correlation provided by Rumpf that is valid for Reynolds numbers in the range [0.01, 100], CD=κ+24/Re, with κ=2 for Re∈[0.01, 10] (±5% error) and κ=1 for Re∈[10, 100] (±20% error) [65]. This C_{D} correlation can be substituted in Eq. 15 using Re=uₜd_{b}ρ_{L}/ρ_{L} to provide the analytical closed-form result in Equation 16.

$${u}_{t} = \frac{- 36 {μ}_{L} + 2 \sqrt{324 {μ}_{L}^{2} + 3 {d}_{b}^{3} {ρ}_{L} κ r {ω}_{s r}^{2} ( - {ρ}_{g} + {ρ}_{L} )}}{3 {d}_{b} {ρ}_{L} κ} \qquad ( Eq . 16 )$$

Stokes' Law. The spherical bubbles can be considered as spherical objects with a very small Reynolds number in a viscous fluid; thus, the terminal velocity for the bubbles can also be estimated from Stokes' law,

$$v = \frac{2}{9} \frac{{ρ}_{water} - {ρ}_{bubble}}{μ} g {R}^{2} .$$

The validity of this approximation is limited to cases where the Reynolds number (Re) is less than 1. To determine which expression should be used, it is necessary to estimate the Reynolds number and evaluate its value in relation to this threshold.

Assumption. To reduce the complexity of the problem, it can be assumed that there is no liquid-gas interface and that the MHD drive is completely filled with liquid. The gas that is not considered is assumed to be located at the center of the MHD device in which the linear velocity and shear stress are minimal; thus, this region can be assumed to be filled with liquid has a negligible influence on the performance of the MHD device. It can also be assumed that the water-electrolyte is rotating as a solid rigid body except in the boundary layer; thus, the fluid can be viewed as a single entity. It is assumed that the system is in a steady state. This means that the fluid properties are assumed to be constant in time and that there are no transient effects or fluctuations that would affect the results. It can be assumed that the Blasius conditions hold to describe a laminar boundary layer that forms on a semi-infinite plate held parallel to a constant unidirectional flow. The rotating flow can be assumed to be parallel to the cylindrical walls along 0. The effect that bubbles may have on ion transport and the Lorentz force can be neglected.

Minimum/Equilibrium Radius. The proper extraction of the produced gas can be achieved when a stable liquid-gas interface radius is maintained. To ensure this stability, the bubble flow rate Q at the interface surface should be higher than the gas production rate resulting from the electrolysis process Q_{produced}. The condition can be obtained if the water-gas interface surface is equal to or bigger than the minimum/equilibrium interface surface, given at a radius, R_{eq}. The minimum/equilibrium interface radius is defined as the radius where the bubble flow rate through the interface surface is equal to the gas production rate considering that the entire surface is entirely covered by bubbles. The bubble flow rate depends on the terminal velocity of the bubble and on the interface surface as, Q=S(r,H)·uₜ(ωₛᵣ, r). With the interface surface being S=(2πr)H, and the terminal velocity given by Eq. 16. By equating the rate of gas production, Q_{produced}, and the rate of gas extraction Q, the desired stable liquid-gas interface radius, Req can be obtained per Equation 17.

Q_{produced}(I)=S(R_{eq},h)uₜ(ωₛᵣ,R_{eq}) (Eq. 17)

Where the distance between electrodes is smaller than the MHD drive height, The device height h can be set equal to the electrode distance de, as the gas is produced in the space between electrodes and it must be first evacuated from this volume. If the calculated interface equilibrium radius R_{eq} using h=de is higher than the electrode internal radius Rᵢ, the surface of the electrodes is covered by gas, eventually stopping the electrolysis process. On the other hand, if R_{eq}<Rᵢ, the gas is evacuated properly from the space between electrodes, and the interface equilibrium radius can be recalculated using h=H, which leads to a much lower radius.

iv. Magnetic Field. The magnetic field generated by the permanent magnet can be computed as the superposition of that induced by N=20 equivalent circular loops located at the top and bottom walls. Each loop has a current Iₗₒₒₚ=Mᵣ(R_{magnet e}−R_{magnet i})/N, resulting in an analogous magnetic system with an analytical solution.

Experimental Results and Model Verification. With a developed model that predicts the angular velocity of water, the terminal velocity of bubbles, and the extraction capacity of the MHD drive, the study validated the accuracy of this model using a ZARM drop tower. The experimental data obtained at ZARM's drop tower showed that the MHD drive enables phase separation in a microgravity environment. The developed analytical model accurately predicts both the angular velocity and the terminal radial velocity of the bubbles.

Because of the inherent limitations in conducting microgravity experiments on Earth, obtaining specific experimental data for the extraction capacity and equilibrium radius of the MHD drive was not feasible due to the duration required to establish the equilibrium radius. Such duration can only be achieved on the International Space Station or through a suborbital flight. To simulate microgravity conditions where the gravitational force experienced by an object or system is significantly reduced, resulting in a state of apparent weightlessness, the study employed a drop tower to provide a controlled environment for an objects or samples to be dropped and experience a brief period of free fall and apparent weightlessness.

Experimental Setup—ZARM's Drop Tower. The study employed a 136 meter ZARM drop tower configured to operate in catapult mode in which a capsule is vertically catapulted to the top of the tower and then drops back down the deceleration chamber, allowing for an extended microgravity experiment time of 9.3 seconds.

MHD Drive Demonstrator. For the MHD drive experiment, the study employed an operating pressure and temperature are 1 atm and 300 K, respectively. The MHD drive demonstrator includes platinum electrodes and neodymium magnets in an aluminum casing.

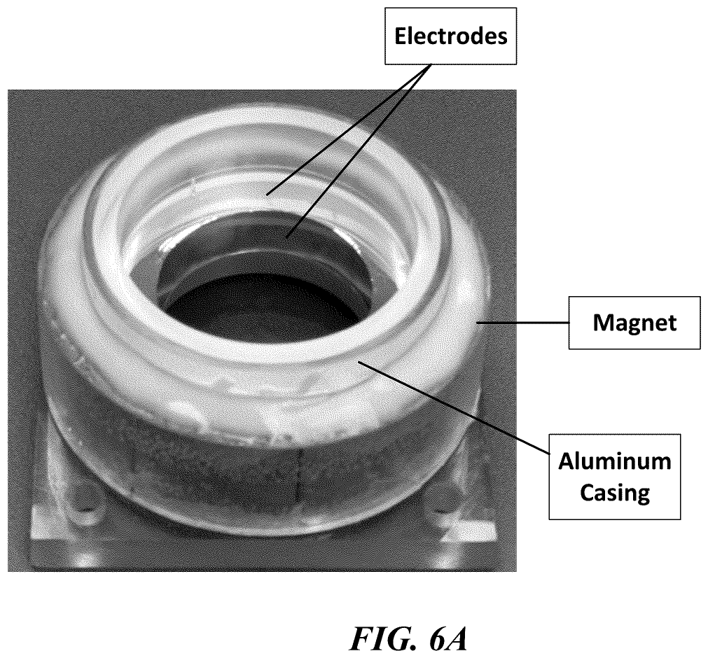

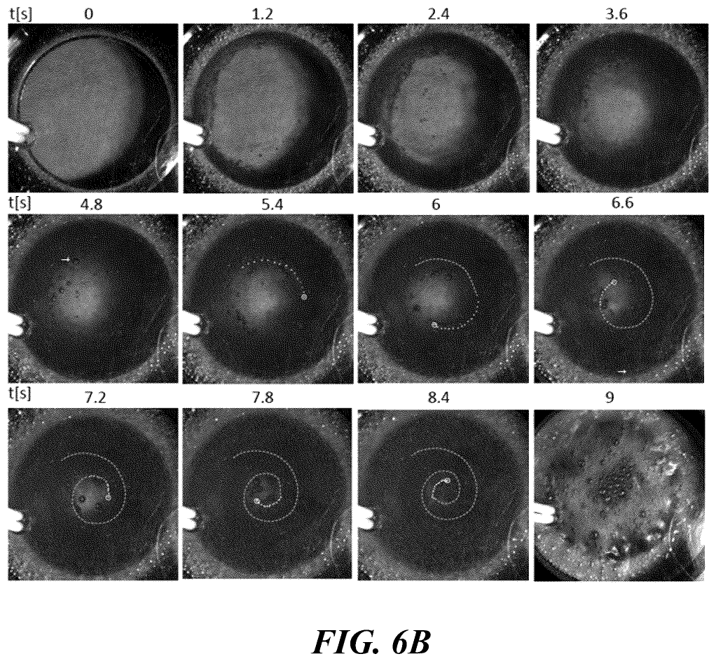

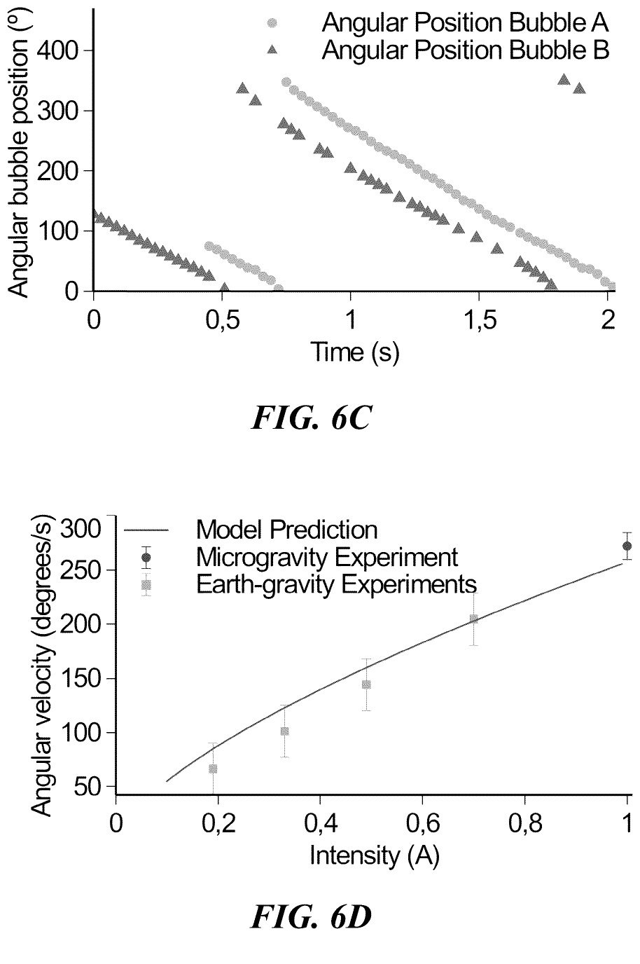

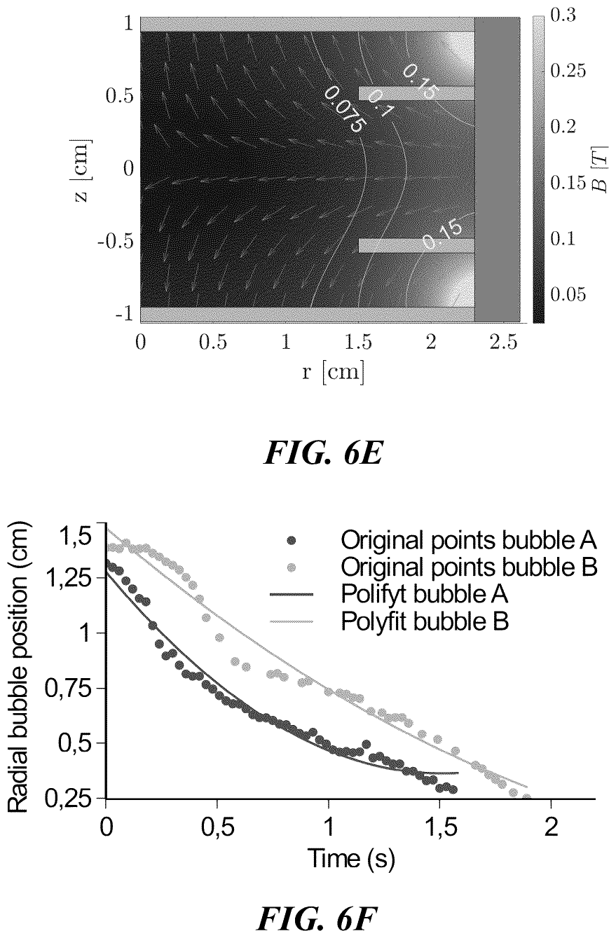

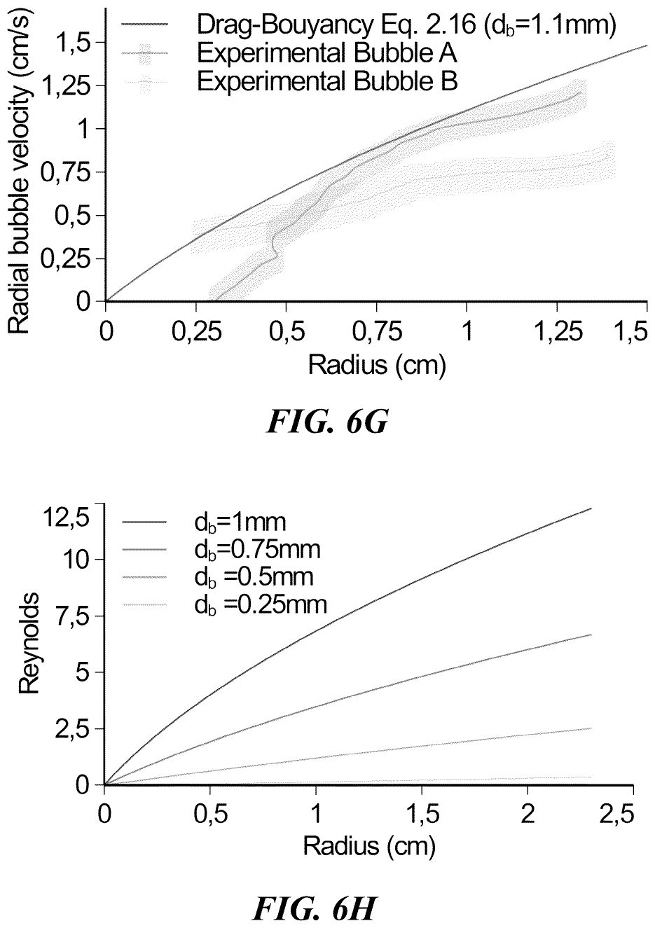

The platinum electrodes provide high stability and resistance to corrosion and oxidation in various electrolytes, including water. Neodymium magnets provide compact size and the ability to generate a strong magnetic field. In the MHD drive demonstrator, a neodymium magnet with a thickness of 3.125 mm (w_{mag}) is positioned around the MHD casing as shown in FIG. 6A.

The MHD drive demonstrator was made of aluminum and had a radius of 2.3 cm and a height of 1.905 cm. The demonstrator used an electrolyte formed of water 1M HClO4+1% isopropyl alcohol. The conductivity of the electrolyte was measured to be κc=7.29±0.65 S/m.

The study used a slow-motion camera to record the evolution of bubbles generated through the electrolysis process for observing the angular velocity of water and the terminal velocity of bubbles, enabling the verification of the developed model.

Experimental Verification. FIG. 6B shows that the Lorentz force initiated a rotation in the liquid, inducing a centrifugal force that caused the bubbles to move toward the center of the MHD device. During a 9.3-second (no “steady state”) experiment, an angular velocity of 183 degrees/s and a significant centripetal acceleration ranging from an ∈ [0.23, 0] m/s2 depending on the distance to the center of the MHD drive was archived. This allows the first bubbles to reach the center of the device as can be observed in FIG. 6B. Images displayed in FIG. 6B were captured with the fluid initially at rest, resulting in larger bubbles compared to those produced later. Higher fluid velocity can prevent the bubbles from growing before detaching.

It can be observed that the radial velocity of bubbles decreased as their radial position decreases. In other words, bubbles closer to the center exhibit slower movement toward it. This behavior can be attributed to the relationship between the terminal velocity of the bubble and the centripetal acceleration, which can be expressed as aₙ=ωₛᵣ²r per Equation 16.

Angular Velocity Model's Prediction Verification. The average angular velocity of these bubbles for “steady state” was found to be 272.96±12.26°/s; further, the angular velocity was shown to be uniform across all radii, as can be seen in FIG. 6C. This result confirms the validity of the paddle wheel model.

The experimental results are compared with the model predictions in FIG. 6D. It can be clearly observed that the model accurately predicts the angular velocity dependency on electrical current intensity. To compute the Lorentz Force, the magnetic field is simulated. The simulated magnetic field is shown in FIG. 6E.

Terminal Velocity Model's Prediction Verification. The terminal velocity of bubbles was measured by tracking the radial position of two larger-than-average bubbles over time, as shown in FIG. 6F. These bubbles had a diameter of 1.1 mm, while the average diameter was around 0.25 mm, which made it possible to accurately measure their position. From this data, the terminal velocity of bubbles was calculated and plotted against the prediction from the model in FIG. 6G. It can be observed that Eq. 16 provides an acceptable estimation (8% average error for Bubble A and 28% average error for Bubble B in FIG. 6G) of the terminal velocity of bubbles for a given diameter and angular velocity.

The results of the Reynolds number analysis plotted in FIG. 6H demonstrates that all the bubbles fall within the range of Re∈[0.01, 10]. Thus, it can be inferred that the Rumpf correlation for the drag coefficient is valid and that if the results for d_{b}=1.1 mm are accurate, Eq. 21 should be accurate for other bubble diameters as well. However, the Stokes correlation would only be valid for the 0.25 mm diameter bubble.

Parametric Analysis. Once the model has been validated with microgravity experiments, it is used to optimize the MHD drive for a CubeSat application. In order to design an optimized architecture, a parametric analysis is first conducted to examine the impact of key factors on the performance of the MHD drive. Specifically, the study explores the effect of varying the external radius of the device, Rₑ, the applied voltage difference ΔV, the distance between electrodes dₑ, and the thickness of the magnet w_{mag} on the device extraction capacity, angular velocity, and gas production. By examining the influence of each parameter on the device performance, the analysis aims to identify the optimal combination of parameters for maximizing the gas production rate.

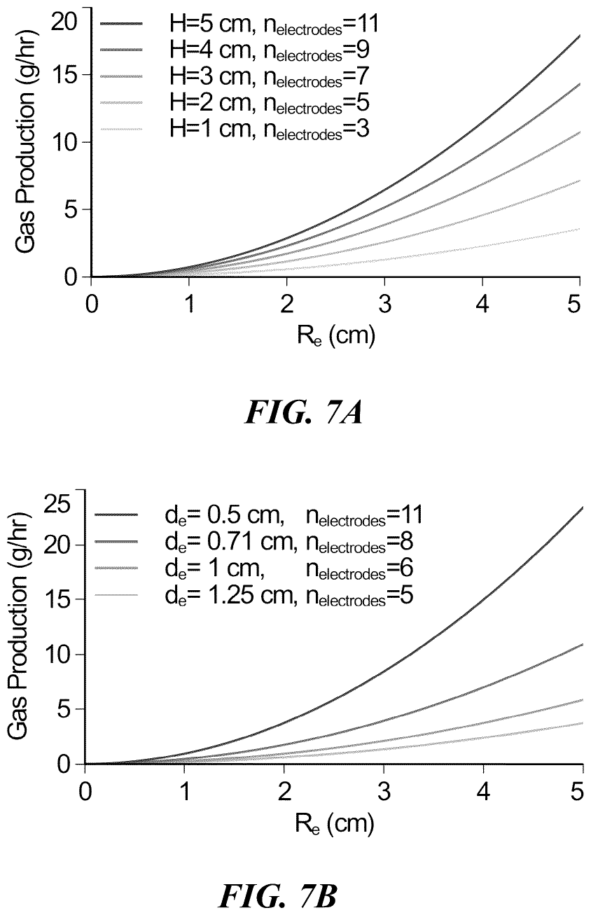

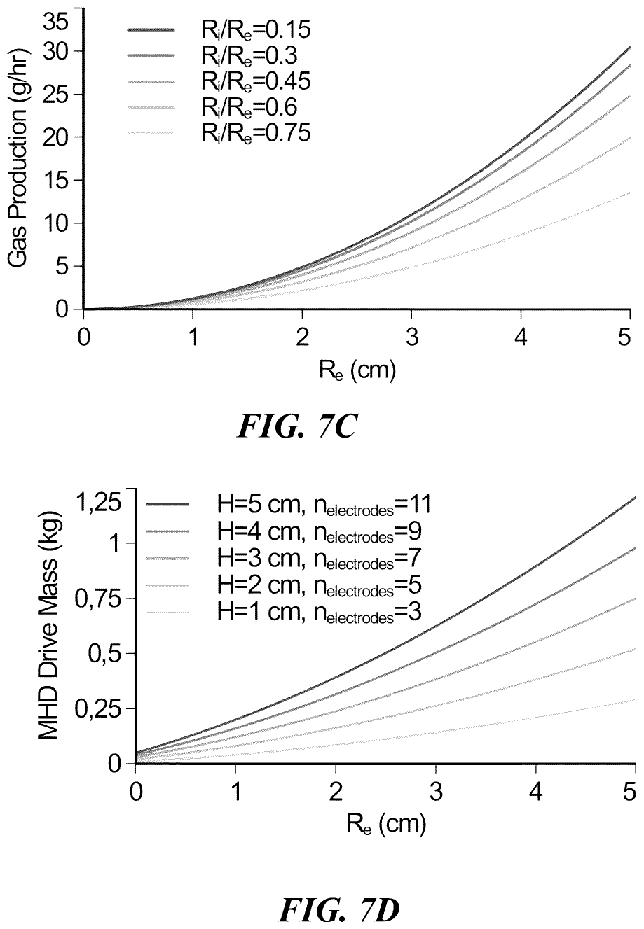

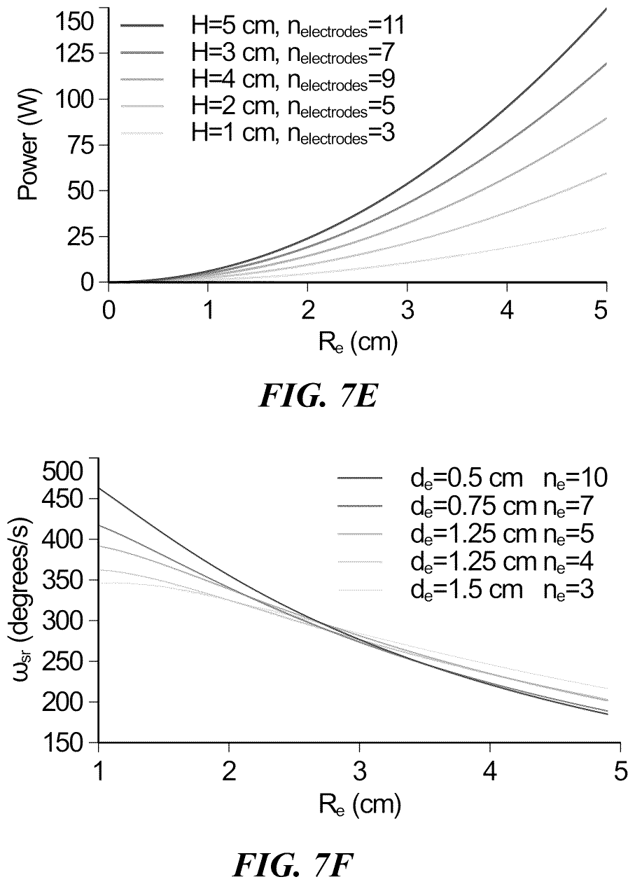

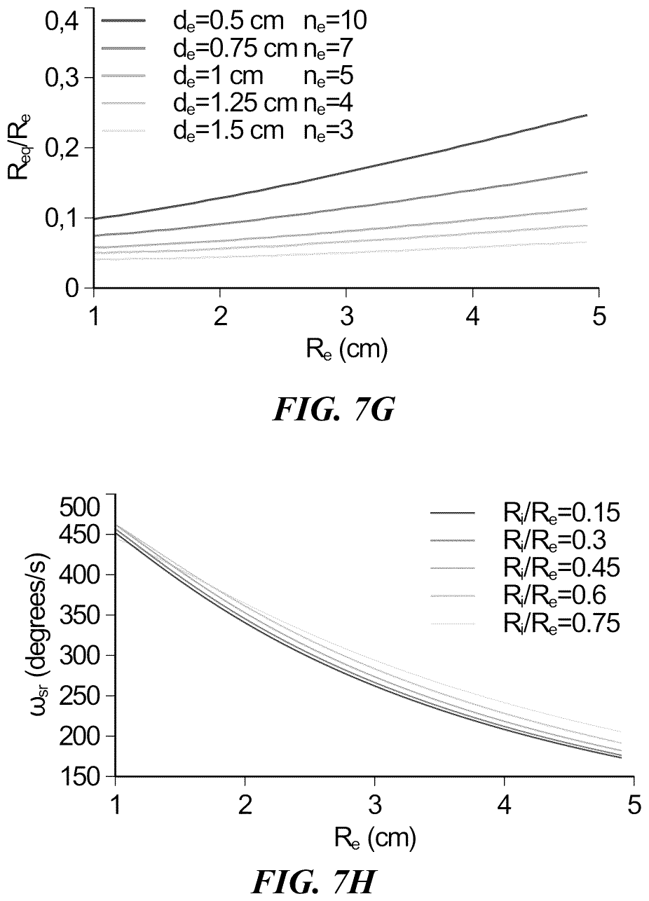

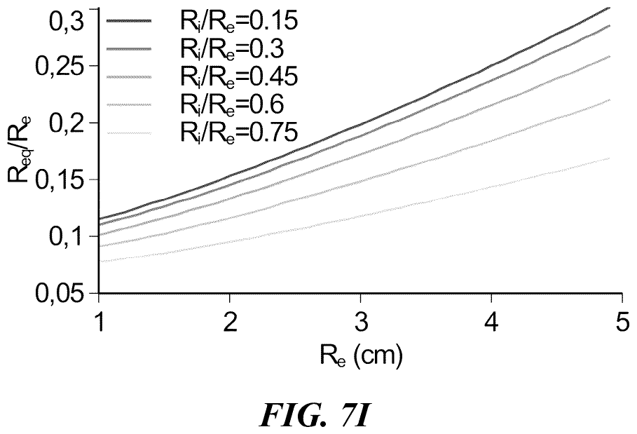

Gas Production. Gas production is dependent on the electrical current intensity, which depends on the electrode surface, S, and on the distance between electrodes, dₑ per Eq. 14. Increasing the number of electrodes nₑ, and decreasing the Rᵢ/Rₑ ratio would increase the electrode surface. If the height of the MHD drive H is increased, more electrodes can be used, which increases gas production, as shown in FIG. 7A. Note that the examples and values in FIGS. 7A-7I are merely illustrative.

On the other hand, for a constant MHD drive height H a lower value of the distance between electrodes allows to include more electrodes in the MHD drive. Moreover, a lower distance between electrodes, dₑ increases the electrical current, Eq. 14, increasing the gas production. The Rᵢ/Rₑ ratio also has an important influence on gas production, as shown in FIG. 7C. For a smaller Rᵢ/Rₑ, the electrode surface and the gas production are increased FIG. 7C. It must be taken into account that the extraction capacity is not taken into consideration in this section. Extraction capacity is considered in further sections.

The increase in gas production with the MHD drive size and with the number of electrodes, nₑ, also increases the mass of the MHD drive and the power that electrolysis requires, as can be observed in FIG. 7D and FIG. 7E.

Electrode Distance and Electrode Number Influence. A lower value of de can lead to a higher electrical current intensity per Eq. 14 and a higher number of electrodes performing electrolysis which results in a stronger Lorentz force. However, having more electrodes also increases the surface where there is friction that slows down the fluid. FIG. 7F shows that for small MHD radii, a small distance between electrodes provides a higher angular velocity than a bigger distance between electrodes. For an MHD drive radius of 5 cm, the angular velocity is higher for a bigger distance between electrodes because the “friction” slowing down the fluid has much more effect for a bigger MHD drive.

A lower value of de can lead to higher gas production, as shown in FIG. 7B. As the gas production increases, the angular velocity and gas extraction capacity do not (for Re>2.8, FIG. 7F). This results in a bigger interface equilibrium radius which can be conceptually understood from Eq. 17. If Q_{produced} is increased (left hand of Eq. 17), the angular velocity, ωₛᵣ and MHD drive height, H, remain constant the interface equilibrium radius, Req, must be bigger.

If the interface equilibrium radius, R_{eq}, is larger than the internal electrode radius, Rᵢ, the gas produced cannot be evacuated at the same rate that it is produced, and the space between the electrodes is partially filled with gas, effectively halting the electrolysis process. This effect is illustrated in FIG. 7G, for small dₑ values, when the gas production increases, the MHD drive cannot evacuate all the gas generated, and the electrolysis process is stopped.

Internal/External Radius Ratio Influence. The internal/external radius ratio Rᵢ/Rₑ can have a strong influence on the electrode surface and gas production as shown in FIG. 7C. This ratio can also influence the angular velocity and the extraction capacity as shown in FIG. 7H and FIG. 7I.

FIG. 7H shows that a low Ri/Re ratio gives a smaller angular velocity than a bigger ratio. This difference increases with a bigger MHD drive size because of the linear velocity and “friction” increase. It can be observed in FIG. 7H that the difference in angular velocity is small. This is because the extended electrode surface increases the “friction” but also the electrical current and the Lorentz force. These opposing effects practically compensate for each other, FIG. 7F.

As for the extraction capacity, for a small Rᵢ/Rₑ the gas production is higher and the angular velocity lower; therefore, the interface equilibrium radius, R_{eq} will be bigger for small Ri/Re ratios, as shown in FIG. 7I.

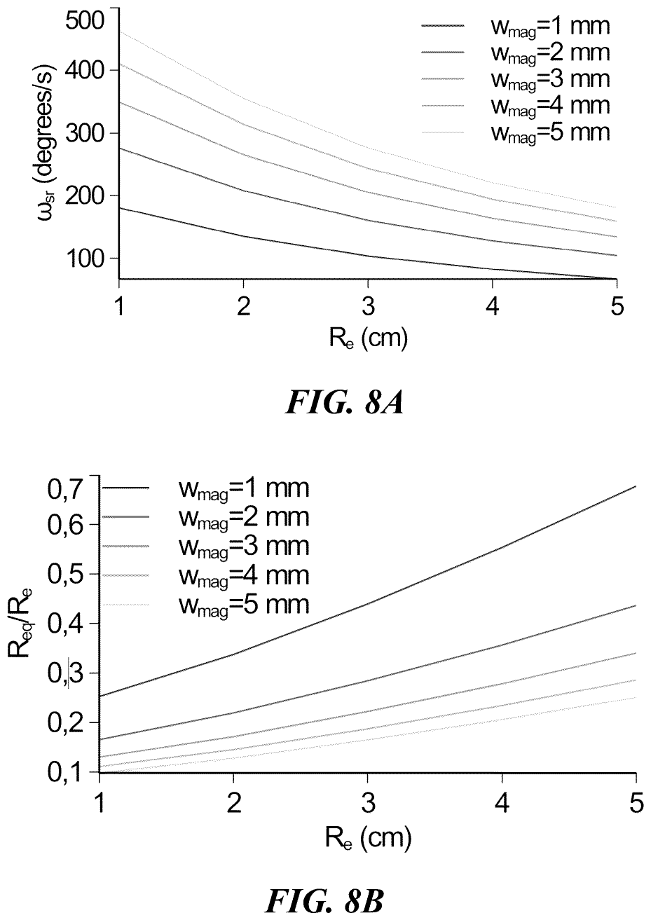

Magnet Thickness Influence. The results show that increasing the magnet thickness significantly improves the extraction capacity of the MHD drive without significantly increasing its size. FIG. 8A and FIG. 8B predict that an increase of just 2 mm in the magnet thickness (w_{mag}) leads to an improvement in angular velocity of 30% which increases the terminal velocity of bubbles uₜ (improving the extraction capacity). This allows to reduce the interface radius in a 23.5%.

A larger magnet can produce a stronger magnetic field, increasing the Lorentz Force and angular velocity. However, gas production remains constant, resulting in a decrease in the interface equilibrium radius for thicker magnets. Conversely, for thin magnets, the applied Lorentz Force is weaker, resulting in a smaller angular velocity. If the gas production rate is maintained and the angular velocity is reduced, the extraction capacity decreases, which can lead to the space between electrodes filling with gas and the electrolysis process stopping.

The results indicate, to optimize performance, the potential difference should be adjusted to maximize the electrical current. However, it is important to avoid exceeding a certain threshold for the potential difference applied across the electrodes. Beyond this threshold, the increase in current becomes limited, leading to an increase in the power used for the same electrical current (P=IΔV).

The dₑ parameter can impact the MHD performance. A smaller dₑ can result in higher gas production while maintaining the angular velocity. However, it also leads to a higher interface equilibrium radius due to increased gas production. If the dₑ is reduced beyond a certain critical point, the gas production rate can exceed the evacuation capacity and can, disrupt the flow of electrons, and reduces the Lorentz Force, the angular velocity, and the extraction capacity. Thus, more bubbles are accumulated, and eventually, the electrolysis process stops.

CubeSat Optimization. The study developed an optimized MHD drive design that can maximize gas production and has a limited size of a 5 cm radius and 5 cm height. These values are chosen so the MHD drive can fit in a 10×10×10 cm Cube-Sat unit in which the MHD drive occupies 5×10×10 cm and gives space for a 5×10×10 cm propulsion system.

The study employed a potential difference of 3 V. At this potential difference, the electrical current varies linearly (ΔV∈[2, 3]) and is far from the asymptotic zone (ΔV>4V) shown in FIG. 5B. The optimization for the CubeSat application may vary depending on the mission. For instance, low mass and power consumption may be prioritized before a high gas production rate for a certain mission, while for another mission, it may be more important to perform high ΔU impulses in a short period of time with CubeSat mass and power consumption not being relevant.

In one optimization, the gas production is maximized without priority to MHD drive mass and power consumption. In this configuration, the electrode surface were maximized, and the distance between electrodes was minimized to increase the current intensity. Also, the magnet thickness is chosen at the minimum value that generates enough Lorentz Force to allow gas extraction. A w_{mag} of 5 mm was used to increase the extraction capacity. Consequently, to maintain the MHD drive radius of 5 cm, the resulting external radius is Re=4.482 cm. A value of dₑ=0.5 cm was found to provide a high gas production rate without preventing gas evacuation. These design parameters led to an angular velocity of 185 degrees/s, a gas production rate of 14 g per hour, and an interface radius of 0.87 cm, which is 19.72% of the external radius, for an operating pressure of 10 bar. The gas produced by this design allowed a change in velocity of, ΔU=4.32 m/s per hour for a 14 kg CubeSat, and a total ΔU=109.35 m/s. The proposed MHD drive design, without considering the additional weight of water, would have a mass of 1 kg.

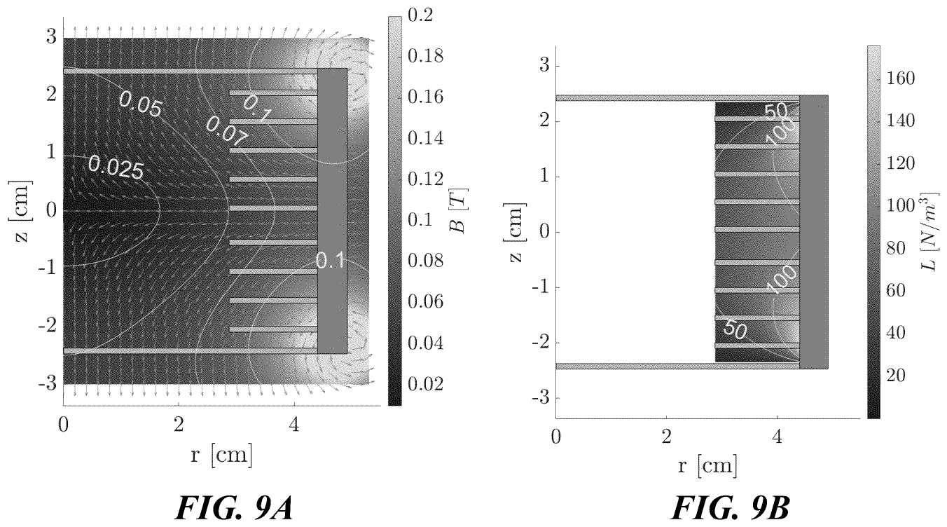

The model computations for the volumetric Lorentz force and the magnetic field for the proposed MHD drive design are shown in FIG. 9A and FIG. 9B, where the proposed geometry can also be observed. The number of electrodes has been increased to maximize gas production. Propulsion System Design. The study considered a propulsion system that (i) is compact to fit within a volume of 5×10×10 cm for a 1U space of a CubeSat, (ii) can burn the gas produced during one hour of electrolysis in less than 30 seconds, and (iii) can desaturate the reaction wheels utilized by the Attitude Control and Determination System (ACDS) of the CubeSat within 10 seconds. The propulsion system for the CubeSat included two main components: (i) a main nozzle attached to a combustion chamber to provide the necessary ΔU for orbital maneuvers and (ii) at least 4 small cold gas thrusters to ensure the correct functioning of the ACDS of the CubeSat. The cold gas thrusters would propel the uncombusted mixture of H2 and O2. The propulsion system included a capacitor sensor to measure the pressure. The propulsion system included a flashback arrestor to block reverse flow from the combustion chamber. Redundancy was ensured by duplicating all valves, except for those leading to the combustion chamber, which requires a higher flow rate.

Optimal Operating Pressure. The operating pressure for a rocket engine can directly impacts its thrust and the available AU and can be determined. In the current propulsion system, the mass flow rate is primarily driven by electrolysis, which produces mass at a slower rate than the mass flow rate through rocket nozzles. The MHD drive produced around 14 grams of gas per hour which is much smaller than the mass flow rate for a thruster, resulting in pulsed propulsion. The gas is produced until the desired pressure is reached, then, the gas is combusted and propelled.

By increasing the operating pressure, the system can raise the final temperature of combustion products, T₁, increasing the average exhaust velocity, v₂, and the characteristic velocity, c* per Equation 18.

$${v}_{2} = \sqrt{\frac{2 k}{k - 1} {RT}_{1} [ 1 - {( \frac{{p}_{2}}{{p}_{1}} )}^{\frac{k - 1}{k}} ]} {c}^{*} = \frac{\sqrt{{kRT}_{1}}}{k \sqrt{{[ \frac{2}{k + 1} ]}^{\frac{k + 1}{k - 1}}}} \qquad ( Eq . 18 )$$

In Equation 18, p₂ is the pressure at the nozzle exit. The increase of the final temperature of combustion products also leads to a higher specific impulse, obtained with NASA's Chemical Equilibrium Applications (CEA) software. The specific impulse can be defined per Equation 19.

$${I}_{sp} = \frac{c * {C}_{F}}{{g}_{0}} \qquad ( Eq . 19 )$$

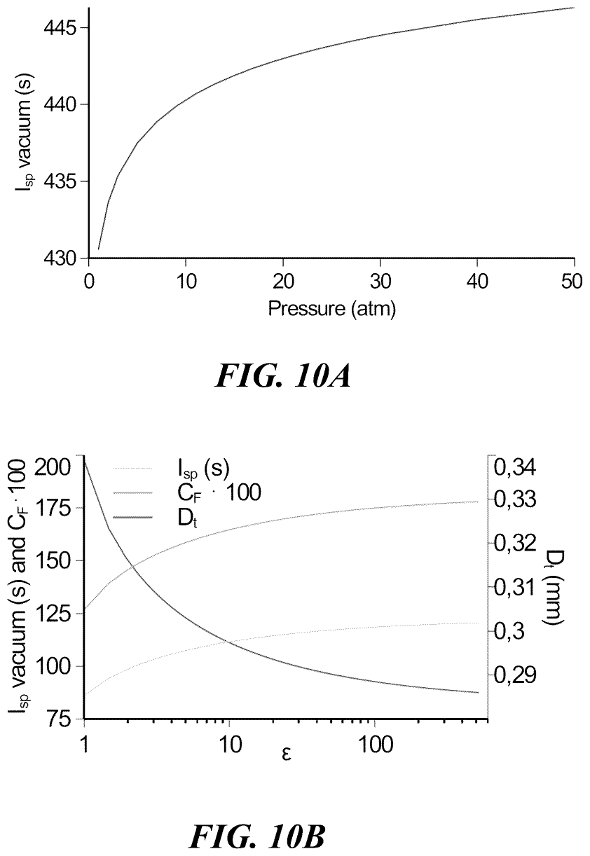

In Equation 19, C_{F} is the thrust coefficient. Beyond a certain pressure value, performance improvements become asymptotic, FIG. 10B. Moreover, higher pressure requirements for the tank and pipes make it less practical to further increase the pressure. Therefore, an operating pressure of 10 bar is chosen, providing a high specific impulse while maintaining relatively low structural requirements for the tank. This pressure is very close to the 150 psia (10.34 bar) pressure chosen in the Cislunar Explorer design.

Nozzle sizing. For the nozzle sizing, the study's objective is to increase the Iₛₚ. To do so, the thrust coefficient, C_{F}, was maximized with a high nozzle expansion ratio, ∈. It can be observed in FIG. 10C that the variation of the thrust coefficient, C_{F}, with nozzle expansion ratio, ∈, is asymptotic. Therefore, if a minimum mass flow rate wants to be maintained through the nozzle, and it is also desired to avoid a long nozzle, the nozzle expansion ratio should not be extremely high. For instance, by setting a ∈=10000, and aiming to maintain a minimum mass flow rate of 1 g/s (in order to avoid excessively long burns), using Eq. 25, the nozzle throat diameter has a minimum value of 1.7 mm and the corresponding nozzle exit diameter would be 170 mm. For a CubeSat, these values are way off-limit. Thus, a balance between the nozzle size and the thrust coefficient must be accomplished.

Combustion Chamber Sizing. For the sizing of the combustion chamber, the study used the characteristic length of the combustion chamber, L*. Then, from the previously obtained combustion chamber volume, V_{cc}=0.899 cm³, the combustion chamber length is L_{cc}=V_{cc}/A_{cc}=2.84 cm. Overall, the total nozzle/combustion chamber length is 4.59 cm, which aligns with the first propulsion system requirement.

Cold Gas Thrusters. The purpose of the thrusters is to desaturate the reaction wheels of the CubeSat. Reaction wheels spin to maintain the CubeSat stability, but over time, they may reach their maximum velocity, and they need to be slowed down. To accomplish this, an external torque is applied, which causes the reaction wheels to slow down. The reaction wheel compensates for the external torque by reducing its rotation speed until it is completely stopped.

For the reaction wheels used on the CubeSat, the maximum momentum stored is 37 mN m s. The CubeSat aims to desaturate the reaction wheels in 10 seconds, which requires a torque of Trequired=momentum/time=3.7 mN·m.

Sizing Cold Gas Thrusters. In FIG. 10C, a clear trend can be observed: as the expansion ratio, ∈, increases, the required throat diameter, Dt, decreases. This phenomenon is driven by the fact that an increase in a specific impulse, Isp, leads to a reduced mass flow rate requirement for generating the same level of thrust. FIG. 10C shows that as the nozzle expansion ratio, E, increases, it has a decreasing effect on the system's performance. Therefore, a nozzle expansion ratio of ∈=200 is set because further increasing the nozzle expansion ratio does not improve the performance of the nozzle, as shown in FIG. 10C, while it increases the exit diameter as Dₑ=Dₜ√∈.

For this nozzle expansion ratio of 200, a thrust coefficient of 1.73, throat diameter of Dt=0.29 mm, exit diameter De=4.1 mm, and assuming θ_{cn}=15° a nozzle length of L n=7.1 mm (Eq. 28) are obtained.

Final Design. Table 2 shows an example final design for a full-sized propulsion system for a CubeSat.

TABLE 2

| | ϵ | Dₜ (mm) | Dₑ (mm) | Lₙ (mm) | \dot{m} (g/s) | Iₛₚ (s) |
|---|---|---|---|---|---|---|
| Cold gas | 200 | 0.29 | 4.1 | 7.1 | 0.097 | 117.7 |
| thruster | | | | | | |
| Main thruster | 62 | 1.27 | 10.6 | 17.5 | 0.5 | 440.2 |

The designed thrusters are shown in a 3D CAD model with an optimized distribution for the entire propulsion system, including the MHD drive, and the elements shown in FIG. 4. The propulsion system has a total mass of 2.2 kg, including 0.35 kg of water. This system provides a AU of 109.35 m/s for a 14 kg CubeSat, (from Eq. 24). The 3D model of the propulsion system for the CubeSat would fit in 1U, that is 10×10×10 cm, and it is shown in FIG. 4.

Discussion

Reliability and mass are among the relevant factors in the design of electrolytic gas generation systems for space applications. This is a challenging technical problem because the absence (or reduction) of buoyancy significantly complicates the separation of gases from liquids, leading to unreliable architectures.

The complexity of CubeSat missions is increasing, and they are in need of safe and practical propulsion systems. Conventional rocket fuels are not suitable for CubeSats due to safety considerations, and alternative propulsion methods such as chemical monopropellants, cold gas, and electric propulsion have their limitations. Electrolysis-driven water-based propulsion has emerged as a viable alternative, and the challenge lies in achieving phase separation of gases and liquids in microgravity conditions. The magnetohydrodynamic drive (MHD drive) offers a potential solution by utilizing the interaction between electrically conducting fluids and magnetic fields to separate hydrogen and oxygen from water.

### CONCLUSION

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations, including controls of the MHD device or drive. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a special purpose computer or special purpose processing machines, ruggedized for space and planetary applications, to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

The following patents, applications, and publications, as listed below and throughout this document, describes various application and systems that could be used in combination the exemplary system and are hereby incorporated by reference in their entirety herein.

### REFERENCES

[1] Clifford, J. E., McCallum, J., Gates, J. T., and Faust, C. L., “Research on the Electrolysis of Water Under Weightless Conditions,” Tech. Rep. AMRL-TDR-62-44, NASA, 1962.
[2] Matsushima, H., Fukunaka, Y., and Kuribayashi, K., “Water electrolysis under microgravity: Part II. Description of gas bubble evolution phenomena,” Electrochimica Acta, Vol. 51, No. 20, 2006, pp. 4190-4198. https://doi.org/10.1016/j.electacta.2005.11.046.
[3] Takada, K. C., and Ghariani, S., A. E. adn Van Keuren, “Advancing the Oxygen Generation Assembly Design to Increase Reliability and Reduce Costs for a Future Long Duration Mission,” 45th International Conference On Environmental Systems, Bellevue, Washington, 2015.
[4] Takada, K., Ridley, A., Keuren, S. V., Baker, P. S., and McDougle, S. H., “Status of the Advanced Oxygen Generation Assembly Design,” 50th International Conference On Environmental Systems, 2021.
[5] Electrolyzer Exergy Analysis for an Environmental Control and Life Support System, ASME International Mechanical Engineering Congress and Exposition, Vol. Volume 6A: Energy, 2018. https://doi.org/10.1115/IMECE2018-88119, v06AT08A068.
[6] Kiuchi, D., Matsushima, H., Fukunaka, Y., and Kuribayashi, K., “Ohmic Resistance Measurement of Bubble Froth Layer in Water Electrolysis under Microgravity,” Journal of The Electrochemical Society, Vol. 153, No. 8, 2006, pp. 138-143. https://doi.org/10.1149/1.2207008.
[7] Sakuma, G., Fukunaka, Y., and Matsushima, H., “Nucleation and growth of electrolytic gas bubbles under microgravity,” International Journal of Hydrogen Energy, Vol. 39, No. 15, 2014, pp. 7638-7645. https://doi.org/10.1016/j.ijhydene.2014.03.059.
[8] Brinkert, K., Richter, M. H., Akay, “O., Liedtke, J., Giersig, M., Fountaine, K. T., and Lewerenz, H.-J., “Efficient solar hydrogen generation in microgravity environment,” Nature Communications, Vol. 9, No. 1, 2018, p. 2527. https://doi.org/10.1038/s41467-018-04844-y.
[9] Jones, H. W., “Using the International Space Station (ISS) Oxygen Generation Assembly (OGA) Is Not Feasible for Mars Transit,” 47th International Conference on Environmental Systems, Vienna, Austria, 2016.
[10] Jones, H. W., “Oxygen Storage Tanks Are Feasible for Mars Transit,” 47th International Conference on Environmental Systems, Charleston, South Carolina, 2017.
[11] Romero-Calvo, A., Schaub, H., and Cano-G'omez, G., “Diamagnetically Enhanced Electrolysis and Phase Separation in Low Gravity,” Journal of Spacecraft and Rockets, Vol. 59, No. 1, 2022, pp. 1-13. https://doi.org/10.2514/1.A35021.
[12] FRIAUF, J. B., “ELECTROMAGNETIC SHIP PROPULSION,” Journal of the American Society for Naval Engineers, Vol. 73, No. 1, 1961, pp. 139-142. https://doi.org/10.1111/j.1559-3584.1961.tb02428.x.
[13] Lin, M.-Y., Hourng, L.-W., and Kuo, C.-W., “The effect of magnetic force on hydrogen production efficiency in water electrolysis,” International Journal of Hydrogen Energy, Vol. 37, No. 2, 2012, pp. 1311-1320. https://doi.org/10.1016/j.ijhydene.2011.10.024, 10th International Conference on Clean Energy 2010.
[14] Liu, Y., ming Pan, L., Liu, H., Chen, T., Yin, S., and Liu, M., “Effects of magnetic field on water electrolysis using foam electrodes,” International Journal of Hydrogen Energy, Vol. 44, No. 3, 2019, pp. 1352-1358. https://doi.org/10.1016/j.ijhydene.2018.11.103.11
[15] Purnami, Hamidi, N., Sasongko, M. N., Widhiyanuriyawan, D., and Wardana, I., “Strengthening external magnetic fields with activated carbon graphene for increasing hydrogen production in water electrolysis,” International Journal of Hydrogen Energy, 2020. https://doi.org/10.1016/j.ijhydene.2020.05.148.
[16] Monfort-Castillo, M., and ‘Alvaro Romero-Calvo, “Magnetohydrodynamic Drive for Water-Based Cube-Sat Propulsion,” AIAA Region II Student Conference, Knoxville, TN, 2019.
[17] Wieland, P., “Designing for Human Presence in Space: An Introduction to Environmental Control and Life Support Systems,” Tech. Rep. RP-1324, NASA, 1994.
[18] Millet, P., and Grigoriev, S., “Chapter 2—Water Electrolysis Technologies,” Renewable Hydrogen Technologies, edited by L. M. Gand'ia, G. Arzamendi, and P. M. Di'eguez, Elsevier, Amsterdam, 2013, pp. 19-41. https://doi.org/https://doi.org/10.1016/B978-0-444-56352-1.00002-7.
[19] Powell, J., Schubert, F., and Jensen, F., “Static feed water electrolysis module,” Tech. Rep. CR-137577, NASA, 1974.
[20] Schubert, F., Wynveen, R., Jensen, F., and Quattrone, P., “Development of an advanced static feed water electrolysis module,” Proc. of the Intersociety Conference on Environmental Systems, 1975.
[21] Fortunato, F. A., Kovach, A. J., and Wolfe, L. E., “Static Feed Water Electrolysis System for Space Station Oxygen and Hydrogen Generation,” SAE Transactions, Vol. 97, 1988, pp. 190-198.
[22] Powell, J., Schubert, F., and Lee, M., “Impact of low gravity on water electrolysis operation,” Tech. Rep. CR-185521, NASA, 1989.
[23] Davenport, R. J., Schubert, F. H., and Grigger, D. J., “Space water electrolysis: space station through advanced missions,” Journal of Power Sources, Vol. 36, No. 3, 1991, pp. 235-250. https://doi.org/https://doi.org/10.1016/0378-7753(91)87004-U, proceedings of the Third Space Electrochemical Research and Technology Conference.
[24] Schubert, F., “Electrolysis Performance Improvement Concept Study (EPICS) Flight Experiment-Reflight,” Tech. Rep. CR-205554, TR-1415-57, NASA, 1997.
[25] Knorr, W., Tan, G., and Witt, J., “The FAE Electrolyser Flight Experiment FAVORITE: Current Development Status and Outlook,” International Conference On Environmental Systems, SAE International, 2004. https://doi.org/https://doi.org/10.4271/2004-01-2490.
[26] Papale, W., and Roy, R., “A Water-Based Propulsion System for Advanced Spacecraft,” Space 2006, 2006, pp. 1-13. https://doi.org/10.2514/6.2006-7240.
[27] Sakurai, M., Sone, Y., Nishida, T., Matsushima, H., and Fukunaka, Y., “Fundamental study of water electrolysis for life support system in space,” Electrochimica Acta, Vol. 100, 2013, pp. 350-357. https://doi.org/https://doi.org/10.1016/j.electacta.2012.11.112.
[28] Romero-Calvo, A., Herrada, M., Cano-G'omez, G., and Schaub, H., “Fully coupled interface-tracking model for axisymmetric ferrohydrodynamic flows,” Applied Mathematical Modelling, Vol. 111, 2022, pp. 836-861. https://doi.org/10.1016/j.apm.2022.06.046.
[29] Doyle, K. P., and Peck, M. A., “Water Electrolysis Propulsion as a Case Study in Resource-Based Spacecraft Architecture,” IEEE Aerospace and Electronic Systems Magazine, Vol. 34, No. 9, 2019, pp. 4-19. https://doi.org/10.1109/MAES.2019.2923312.
[30] Doyle, K. P., and Peck, M. A., “Water Electrolysis for Propulsion of a Crewed Mars Mission,” Journal of Spacecraft and Rockets, Vol. 57, No. 6, 2020, pp. 1103-1117. https://doi.org/10.2514/1.A34632.
[31] A. Mehrparvar et al., “Cubesat design specification rev.13,” California Polytechnic State University, Tech. Rep. CP-CDS-R13, 2014. [Online]. Available: https://static1.squarespace.com/static/5418c831e4b0fa4ecac lbacd/t/56e9b62337013b6c063a655 a/1458157095454/cds rev13 fina12.pdf.
[32] H. Heidt, J. Puig-Suari, A. Moore, S. Nakasuka, and R. Twiggs, “Cubesat: A new generation of picosatellite for education and industry low-cost space experimentation,” in 14th Annu. AIAA/USU Conf. Small Satellites, SSC00-V-5, 2000. [Online]. Available: https:/digitalcommons.usu.edu/cgi/viewcontent.cgi?article=2069&context=smallsat.
[33] J. Bouwmeester and J. Guo, “Survey of worldwide pico- and nanosatellite missions, distributions and subsystem technology,” Acta Astronautica, vol. 67, no. 7, pp. 854-862, 2010. DOI: 10.1016/j.actaastro.2010.06.004.
[34] S. Nayyar, S. Kumar, and V. Suhag, “Earthquake signature detection using cubesat technology,” Journal of Advance Research in Electrical and Electronics Engineering, vol. 1, no. 2, pp. 04-06, 2014. DOI: 10.53555/nneee.v1i2.256.
[35] D. Evans and M. Merri, “Ops-sat: A esa nanosatellite for accelerating innovation in satellite control,” in SpaceOps 2014 Conference, AIAA Paper 2014-1702, Pasadena, C A, 2014. DOI: 10.2514/6.2014-1702.
[36] C. Kitts et al., “Flight results from the genesat-1 biological microsatellite mission,” in 21st Annual AIAA/USU Conference on Small Satellites, Santa Clara, CA, 2007. [Online]. Available: https://digitalcommons.usu.edu/cgi/viewcontent.cgi?article=1502&context=smallsat.
[37] J. Schoolcraft, A. Klesh, and T.Werne, “Marco: Interplanetary mission development on a cubesat scale,” Space Operations: Contributions from the Global Community, pp. 221-231, 2017. DOI: 10.2514/6.2016-2491.
[38] D. M. McIntosh, J. D. Baker, and J. A. Matus, “The nasa cubesat missions flying on artemis-1,” in Pre-Conference Workshop Session VII: Instruments/Science II, Utah State University, Logan, U T, 2020. [Online]. Available: https://digitalcommons.usu.edu/smallsat/2020/a112020/44/.
[39] R. Funase et al., “Mission to earth—moon lagrange point by a 6u cubesat: Equuleus,” IEEE Aerospace and Electronic Systems Magazine, vol. 35, no. 3, pp. 30-44, 2020. DOI: 10.1109/MAES.2019.2955577. 57
[40] N. Morishita et al., “Development of a super-small solid rocket motor for omotenashi,” in Technical Poster Session IV, Utah State University, Logan, U T, 2020. [Online]. Available: https://digitalcommons.usu.edu/smallsat/2020/a112020/256/.
[41] V. Di Tana, B. Cotugno, S. Simonetti, G. Mascetti, E. Scorzafava, and S. Pirrotta, “Argomoon: There is a nano-eyewitness on the sls,” IEEE Aerospace and Electronic Systems Magazine, vol. 34, no. 4, pp. 30-36, 2019. DOI: 10.1109/MAES.2019. 2911138.
[42] T. Prejean, “Nanoracks cubesat deployer,” NanoRacks, Tech. Rep. NR-NRCSDS0003, 2018. [Online]. Available: https://nanoracks.com/wp-content/uploads/Nanoracks-CubeSat-Deployer-NRCSD-IDD.pdf.
[43] F. John, K. Jeff, C. Corey, K. Patel, and B. P. V. Orbit, “Launcherone now in orbit: Dedicated air-launch brings proven, responsive space,” VirginOrbit, Tech. Rep. SSC21-IV-05, 2021. [Online]. Available: https://digitalcommons.usu.edu/cgi/viewcontent.cgi?article=5034&context=smallsat.
[44] G. M. Huggins et al., “Development of a cubesat-scale green monopropellant propulsion system for nasa's lunar flashlight mission,” in AIAA Scitech 2021 Forum, Virtual Event, 2021, p. 1976. DOI: 10.2514/6.2021-1976.
[45] K. Sarda, C. Grant, S. Eagleson, D. D. Kekez, and R. E. Zee, “Canadian Advanced Nanospace Experiment 2: Om-Orbit Experience with an Innovative Three-Kilogram Satellite,” in 4S Symposium Small Satellites Systems and Services, L. Conroy, Ed., ser. ESA Special Publication, Noordwijk, Netherlands: European Space Agency, vol. 660, August 2008, 62, p. 62. [Online]. Available: https://ui.adsabs.harvard.edu/abs/2008ESASP.660E.62S.
[46] G. Manzoni and Y. L. Brama, “Cubesat micropropulsion characterization in low earth orbit,” in Proceedings of the 29th AIAA/USU Conference Small Satell, SSC15—IV-5, Logan, U T, 2015. [Online]. Available: https://digitalcommons.usu.edu/smallsat/2015/a112015/26/.
[47] N. Hejmanowski, C. Woodruff, R. Burton, D. Carroll, and A. Palla, “Cubesat high impulse propulsion system (chips) design and performance,” in Proceedings of 63rd JANNAF Propulsion Meeting (8th Spacecraft Propulsion), Phoenix, AZ, December 2016, p. 1. [Online]. Available: https://www.researchgate.net/publication/323225650 CubeSat High Impulse Propulsion System CHIPS Design and Performance.
[48] M. Coletti, F. Guarducci, and S. Gabriel, “A micro ppt for cubesat application: Design and preliminary experimental results,” Acta Astronautica, vol. 69, no. 3, pp. 200-208, 2011. DOI: 10.1016/j.actaastro.2011.03.008. 58
[49] D. Alhorn, “Nanosail-d: The small satellite that could!” AIAA/USU Conference Small Satell, Technical Session VI: Small but Mighty, Tech. Rep. SSC11-VI-1, 2011. [Online]. Available: https://digitalcommons.usu.edu/smallsat/2011/a112011/37/.
[50] G. Sutton and 0. Biblarz, Rocket Propulsion Elements. Hoboken, New Jersey:Wiley, 2001, ch. 5, p. 128, ISBN: 9780471326427. M. Tsay, D. Lafko, J. Zwahlen, and W. Costa, “Development of busek 0.5 n green monopropellant thruster,” in 27th Anual AIAA/USU Conference on Small Satelites, 11 Tech Cir, Natick, MA 01760, 2013. [Online]. Available: https://digitalcommons. usu.edu/smallsat/2013/a112013/97/.
[51] J. Mansell et al., “Orbit and attitude performance of the lightsail 2 solar sail spacecraft,” in AIAA Scitech 2020 Forum. DOI: 10.2514/6.2020-2177.
[52] D. Hinkley, “A novel cold gas propulsion system for nanosatellites and picosatellites,” in 22nd AIAA/USU Conference on Small Satellite, Logan, U T., 2008. [Online]. Available: https://digitalcommons.usu.edu/smallsat/2008/a112008/44/. K. Lemmer, “Propulsion for cubesats,” Acta Astronautica, vol. 134, pp. 231-243, 2017. DOI: 10.1016/j.actaastro.2017.01.048.
[53] T. Zhuang, A. Shashurin, T. Denz, D. Chichka, and M. Keidar, “Micro-vacuum arc thruster with extended lifetime,” in 45th AIAA/ASME/SAE/ASEE Joint Propulsion Conference, Denver, Colorado, AIAA Paper 2009-4820, 2009. DOI: 10.2514/6.2009-4820.
[54] M. Tsay, J. Frongillo, K. Hohman, and B. K. Malphrus, “Lunarcube: A deep space 6u cubesat with mission enabling ion propulsion technology,” Technical Session XI: Advanced Technologies III, Tech. Rep. SSC15-XI-1, 2015. [Online]. Available: https://digitalcommons.usu.edu/smallsat/2015/a112015/71/.
[55] D. Krejci, M. G. Jenkins, and P. Lozano, “Staging of electric propulsion systems: Enabling an interplanetary cubesat,” Acta Astronautica, vol. 160, pp. 175-182, 2019. DOI: 10.1016/j.actaastro.2019.04.031.
[56] J. Mueller, R. Hofer, and J. Ziemer, Survey of propulsion technologies applicable to cubesats, version V1, 2010. DOI: 2014/41627. D. Lev, R. M. Myers, K. M. Lemmer, J. Kolbeck, H. Koizumi, and K. Polzin, “The technological and commercial expansion of electric propulsion,” Acta Astronautica, vol. 159, pp. 213-227, 2019. DOI: 10.1016/j.actaastro.2019.03.058. 59
[57] A. van Paridon and E. Petro, “Survey of water powered propulsion systems,” in AIAA Propulsion and Energy 2021 Forum, AIAA Paper 2021-3566, 2021. DOI: 10.2514/6. 2021-3566.
[58] Aro aurora resistojet one datasheet, Aurora Propulsion Technologies, 2020. [Online]. Available: https://aurorapt.fi/downloads/ARO.pdf.
[59] Y. Nogawa and H. Tahara, “Evolutional electrical propulsion with water propellant dc arcjet,” in 35th International Electric Propulsion Conference, Atlanta, G A, 2017, pp. 2017-413. [Online]. Available: http://electricrocket.org/IEPC/IEPC 2017 413. pdf.
[60] H. Koizumi et al., “Assessment of micropropulsion system unifying water ion thrusters and water resistojet thrusters,” Journal of Spacecraft and Rockets, vol. 56, no. 5, pp. 1400-1408, 2019. DOI: 10.2514/1.A34407.
[61] D. Kirtley, A. Pancotti, J. Slough, and C. Pihl, “Steady operation of an frc thruster on martian atmosphere and liquid water propellants,” in 48th AIAA/ASME/SAE/ASEE Joint Propulsion Conference, AIAA Paper 2012-4071, 2012. DOI: 10.2514/6.2012-4071. [36] A. Schwertheim and A. Knoll, “The water electrolysis hall effect thruster (wet-het): Paving the way to dual mode chemical-electric water propulsion,” in 36th International electric propulsion conference, Viena, Austia, 2019, p. 259. [Online]. Available: http://electricrocket.org/2019/259.pdf0.
[62] S. Rabade, N. Barba, L. Garvie, and J. Thangavelautham, “The case for solar thermal steam propulsion system for interplanetary travel: Enabling simplified isru utilizing neos and small bodies,” in Proceedings of the 67th International Astronautical Congress, Guadalajara, Mejico, 2016. [Online]. Available: https://asteroid.arizona. edu/iac2016 steam propulsion.pdf.
[63] R. dₑ Levie, “The electrolysis of water,” Journal of Electroanalytical Chemistry, vol. 476, no. 1, pp. 92-93, 1999. DOI: 10.1016/S0022-0728(99)00365-4.
[64] S. Trasatti, “Water electrolysis: Who first?” Journal of Electroanalytical Chemistry, vol. 476, no. 1, pp. 90-91, 1999. DOI: 10.1016/S0022-0728(99)00364-2. 60
[65] D. Newman, “Water electrolysis reaction control system,” in Proc. of the 7th Liquid Propulsion Symposium, Chemical Propulsion Information Agency Publications, vol. 72, 1965, pp. 105-114.
[66] R. Roy, “Backwards Runs the Reaction,” Mechanical Engineering, vol. 130, no. 04, pp. 32-36, April 2008. DOI: 10.1115/1.2008-APR-3.
[67] K. James, T. Moser, A. Conley, J. Slostad, and R. Hoyt, “Performance characterization of the hydros water electrolysis thruster,” in Proc. of the Small Satellite Conference 2015. Paper SSC15-XI-5, 2015, pp. 1-7. [Online]. Available: https://digitalcommons.usu.edu/smallsat/2015/a112015/75/.
[68] K. Burke, “Small portable pem fuel cell systems for nasa exploration missions,” NASA, Tech. Rep. TM-2005-213994, 2005. [Online]. Available: https://ntrs.nasa. gov/citations/20060008648.
[69] D. Bents, V. Scullin, B. Chang, D. Johnson, and C. G. snf I. J. Jakupca, “Hydrogenoxygen pem regenerative fuel cell development at the nasa glenn research center,” NASA, Tech. Rep. TM-2005-214032, 2005. [Online]. Available: https://ntrs.nasa. gov/api/citations/20060008697/downloads/20060008697.pdf.
[70] R. J. Erickson, J. Howe, G. W. Kulp, and S. P. Van Keuren, “International space station united states orbital segment oxygen generation system on-orbit operational experience,” SAE International Journal of Aerospace, vol. 1, no. 2008-01-1962, pp. 15-24, 2008. DOI: 10.4271/2008-01-1962.
[71] D. E. Tilton and C. L. Tilton, Entrained droplet separator, U.S. Pat. No. 5,314,529, 1994.
[72] A. Zucherman et al., “Cislunar explorers: Lessons learned from the development of an interplanetary cubesat,” in 34th AIAA/USU Conference on Small Satellites, Logan, U T, 2020. [Online]. Available: https://digitalcommons.usu.edu/smallsat/2020/a112020/92/.
[73] M. Sakurai, A. Shima, Y. Sone, M. Ohnishi, S. Tachihara, and T. Ito, “Air revitalization development of oxygen generation demonstration on jem (kibo) for manned space exploration,” in 44th International Conference on Environmental Systems, Tucson, Arizona, 2014, pp. 1-7. [Online]. Available: http://hdl.handle.net/2346/59644. 61
[74] M. M. Weislogel, E. A. Thomas, and J. C. Graf, “A novel device addressing design challenges for passive fluid phase separations aboard spacecraft,” Microgravity Science and Technology, vol. 21, no. 3, p. 257, 2008. DOI: 10.1007/s12217-008-9091-7.
[75] A′. Romero-Calvo, O″. Akay, H. Schaub, and K. Brinkert, “Magnetic phase separation in microgravity,” npj Microgravity, vol. 8, no. 1, p. 32, August 2022. DOI: 10.1038/s41526-022-00212-9.
[76] D. J. Griffiths, Introduction to electrodynamics. Cambridge, England: Pearson Cambridge University Press, 2017, ISBN: “9780138598518”. DOI: 10.1017/9781108333511.
[77] Z. FABmbH and A. Fallturm, Zarm drop tower bremen user manual, 2008. [Online]. Available: https://www.zarm.uni-bremen.de/fileadmin/images/droptower/downloads/Users Manual 0412.pdf.
[78] J. B. Heywood, Internal combustion engine fundamentals. New York City: McGraw-Hill Education, 2018, ISBN: 9780070286375. H. Schlichting and J. Kestin, Boundary layer theory. Midtown Manhattan, New York City: Springer, 1961, vol. 121, ISBN: 9780070553293.
[79] B. R. Munson, T. H. Okiishi, W. W. Huebsch, and A. P. Rothmayer, Fluid mechanics. Wiley Singapore, 2013, ISBN: 978-1-118-62312-1.
[80] M. A. Day, “The no-slip condition of fluid dynamics,” Erkenntnis, vol. 33, no. 3, pp. 285-296, 1990. DOI: 10.1007/BF00717588.
[81] R. Hibbeler, Mechanics of Materials. New Jersey USA: Pearson Education, 2004, ISBN: 9781292178202.
[82] M. Carmo and D. Stolten, “Chapter 4—energy storage using hydrogen produced from excess renewable electricity: Power to hydrogen,” in Science and Engineering of Hydrogen-Based Energy Technologies, P. E. V. de Miranda, Ed., Academic Press, 2019, pp. 165-199, ISBN: 978-0-12-814251-6. DOI: 10.1016/B978-0-12-814251-6.00004-6. [Online]. Available: https://www.sciencedirect.com/science/article/pii/B9780128142516000046. 62
[83] A. J. Bard, L. R. Faulkner, et al., Electrochemical Methods: Fundamentals and applications. Wiley New York, 2001, vol. 2, pp. 580-632, ISBN: 978-O-471-04372-0.
[84] S. S. Molokov, R. Moreau, and H. K. Moffatt, Magnetohydrodynamics: Historical evolution and trends. Springer Science & Business Media, 2007, vol. 80, ISBN: 9781402048326.
[85] R. Clift, J. R. Grace, and M. E. Weber, Bubbles, drops, and particles. Courier Corporation, North Chelmsford, Massachusetts, 2005, ISBN: 9780121769505.
[86] L. Liu, H. Yan, G. Zhao, and J. Zhuang, “Experimental studies on the terminal velocity of air bubbles in water and glycerol aqueous solution,” Experimental Thermal and Fluid Science, vol. 78, pp. 254-265, 2016. DOI: 10.1016/j.expthermflusci.2016. 06.011.
[87] “European aircraft parabolic flights for microgravity research, applications and exploration: A review,” REACH, vol. 1, pp. 11-19, 2016. DOI: 10.1016/j.reach.2016. 05.002.
[88] NASA, Chemical equilibrium applications, 1994. [Online]. Available: https://cearun. grc.nasa.gov/.
[89] D. K. Huzel, Modern engineering for design of liquid-propellant rocket engines. AIAA, 1992, vol. 147, ISBN: 978-1-56347-013-4.
[90] D. H. Huang and D. K. Huzel, Design of Thrust Chambers and Other Combustion Devices. 1992, ch. 4, pp. 67-134, ISBN: 978-1-56347-013-4. DOI: 10.2514/5. 9781600866197.0067.0134.

What is claimed is:

1. A magnetohydrodynamic device configured for gas production and phase separation, the device comprising:
a housing having a first side, a second side, and a sidewall defining an inner volume;
one or more permanent magnets or electromagnetic source modules arranged adjacent to the sidewall and configured to generate static magnetic or electromagnetic fields directed radially inwards towards the inner volume;
at least two electrodes, including a first electrode and a second electrode, disposed within the inner volume and spaced apart from each other in an axial direction;
an inlet defined by an opening in the housing and configured to deliver a liquid to the inner volume; and
an outlet defined in the housing at the first side and configured to expel a gas, generated from the liquid, from the inner volume;
wherein a current is applied between the first and second electrodes (a), and in the static magnetic or electromagnetic field, to generate a Lorentz force in a direction perpendicular to both (i) the applied current and (ii) the static magnetic or electromagnetic fields, the Lorentz force exerting a circumferential acceleration on the liquid to form a vortical flow within the inner volume and (b) the first and second electrodes electrolyze the liquid to form the gas while the vortical flow urges the gas toward the outlet through the generation of centripetal acceleration.

2. The device of claim 1, wherein the liquid includes an electrolyte, and the first and second electrodes, collectively, form an electrolytic cell.

3. The device of claim 2, wherein the vortical flow, while the device is in a microgravity or low gravity environment, separates the liquid from the gas by urging the gas toward the outlet and urging the liquid toward the sidewall.

4. The device of claim 1, wherein the housing is cylindrical.

5. The device of claim 1, the device further comprising:
a central membrane extending at least partially between the first electrode and the second electrode,
wherein the first and second electrodes form an electrolytic cell, wherein the first electrode is closer to the first side of the housing and the second electrode is closer to the second side of the housing.

6. The device of claim 5, further comprising:
a second outlet defined in the housing at the second side and configured to expel a second gas, generated from the liquid, from the inner volume of the housing,
wherein the gas as a first gas is generated from the liquid at the first electrode, and wherein the first and second electrodes electrolyze the liquid to form the second gas at the second electrode while the vortical flow urges the second gas toward the second outlet.

7. The device of claim 6, wherein the central membrane that separates the first gas from the second gas.

8. The device of claim 7, wherein the liquid is water, the first gas is hydrogen gas, and the second gas is oxygen gas.

9. The device of claim 7, wherein the outlet is configured to expel the gas in combination with a liquid form of the gas, and wherein the vortical flow within the inner volume urges the gas and the liquid form of the gas to exit through the outlet.

10. The device of claim 1, wherein the first electrode and the second electrode are configured as a photoelectrochemical cell that is configured to electrolyze the liquid using light that is shown on a portion of the first electrode and the second electrode.

11. The device of claim 1, wherein the gas is directed to a combustion chamber, or a storage tank thereof, for use in propulsion, life support, in-situ resource utilization, or carbon dioxide reduction.

12. The device of claim 1, wherein the at least two electrodes further includes a third electrode and a fourth electrode,
wherein the current is applied between the third and fourth electrodes electrolyze the liquid to form the gas while the vortical flow urges the gas toward the outlet.

13. The device of claim 12, wherein the third and fourth electrodes is in the static magnetic or electromagnetic field and generate the Lorentz force in the direction to form the vortical flow when the current is applied thereto.

14. The device of claim 1, wherein the gas is directed to a life support system or a storage tank thereof.

15. The device of claim 1 further comprising:
a motor configured to rotate the housing, the rotation assisting in formation of the vortical flow.

16. The device of claim 1 further comprising:
a pump, wherein the pump is configured to move the liquid into the housing at a pre-defined volume or velocity.

17. The device of claim 1 further comprising:
a storage tank configured to house the expelled gas.

18. A method of performing electrolysis comprising:
providing a magnetohydrodynamic drive having (i) at least two electrodes and (ii) one or more permanent magnets or electromagnetic source modules;
causing a liquid electrolyte to flow into the magnetohydrodynamic drive via an inlet; and
generating and separating at least one gas from the liquid electrolyte by:
applying a current between the at least two electrodes in proximity to a radially directed static magnetic or electromagnetic field produced by the one or more permanent magnets or electromagnetic source modules, (i) to generate a Lorentz force in a direction perpendicular to both of the applied current and the static magnetic or electromagnetic fields, the Lorentz force exerting a centripetal acceleration on the liquid electrolyte to form a vortical flow within the magnetohydrodynamic drive, and (ii) to electrolyze the liquid electrolyte to form the at least one gas while the vortical flow urges the gas toward an outlet.

19. The method of claim 18, further comprising:
expelling, via the outlet of the magnetohydrodynamic drive, the at least one gas from the magnetohydrodynamic drive.

20. The method of claim 19, wherein the liquid electrolyte includes water or a solution.
